(19) United States
(12) Patent Application Publication
(10) Pub. No.: US 2020/0333423 A1
(43) Pub. Date: Oct. 22, 2020

(54) SOUND SOURCE DIRECTION ESTIMATION DEVICE AND METHOD, AND PROGRAM

(71) Applicant: SONY CORPORATION, TOKYO (JP)

(72) Inventors: KAZUKI OCHIAI, KANAGAWA (JP); SHUSUKE TAKAHASHI, CHIBA (JP); AKIRA TAKAHASHI, SAITAMA (JP); KAZUYA TATEISHI, TOKYO (JP)

(21) Appl. No.: 16/753,252

(22) PCT Filed: Sep. 27, 2018
(86) PCT No.: PCT/JP2018/035843

§ 371 Date: Apr. 2, 2020

(30) Foreign Application Priority Data
Oct. 11, 2017 (JP) 2017-197870

(51) Int. Cl. G01S 3/808; H04R 1/32

(52) U.S. Cl. CPC G01S 3/8083; H04R 1/326

(57) ABSTRACT

The present technology relates to a sound source direction estimation device and method, and a program that can reduce an operation amount for estimating a direction of a target sound source. A first estimation unit estimates a first horizontal angle that is a horizontal angle of a sound source direction from an input acoustic signal. A second estimation unit estimates a second horizontal angle that is the horizontal angle of the sound source direction and an elevation angle, with respect to the first horizontal angle, in a predetermined range near the first horizontal angle. The present technology can be applied, in a case where a voice is uttered from a surrounding sound source (for example, a person), to a device having a function of estimating the direction in which the voice is uttered.

### TECHNICAL FIELD

The present technology relates to a sound source direction estimation device and method, and a program, and more particularly to a sound source direction estimation device and method, and a program that can reduce an operation amount for estimating a direction of a target sound source.

### BACKGROUND ART

In an indoor environment, there is a device that presents in which direction voice interaction is performed with a user by turning a face (front surface) of the device, turning on a light emitting diode (LED), and the like. Such a device can preferably present the direction of the user accurately. This is because, when indicating to the user that utterance is being received, if the direction is wrong, there is a possibility that the user may be stressed.

In a case where the device includes a camera, the direction can be estimated using technology of face recognition and the like. However, in a case where no user is included in the camera's angle of view, or in a case where there are multiple users around the device, it is advantageous to perform direction estimation by voice, and it is preferable to estimate the direction (both azimuth angle (horizontal angle) and elevation angle) three-dimensionally.

Furthermore, voice recognition is required for voice interaction, and accuracy is required for sound source direction estimation under indoor noise reverberation in order to allow speech emphasis and extraction to operate properly. It is known to use the multiple signal classification (MUSIC) method for estimating the sound source direction (for example, Patent Document 1).

### CITATION LIST

### Patent Document

Patent Document 1: Japanese Patent Application Laid-Open No. 2012-150237

### SUMMARY OF THE INVENTION

### Problems to be Solved by the Invention

If a microphone array that collects a voice is linearly arranged, it is difficult to estimate the three-dimensionally accurate direction due to symmetry thereof, and thus the microphone array needs to be arranged on a plane or three-dimensionally.

It is also possible to perform direction estimation assuming that a sound source exists at a specified elevation angle with respect to the microphone array (for example, on the same horizontal plane as the microphone array), and sometimes direction estimation is performed in such a way. However, if the elevation angle deviates greatly from the assumption, the assumption will not hold and an error in the estimated direction will increase.

Whereas the technique of estimating the sound source direction by the MUSIC method can improve performance, the operation amount increases and a load increases. In particular, when trying to estimate not only the horizontal direction but also the elevation angle, that is, when trying to perform estimation three-dimensionally, the operation amount becomes very large.

The present technology has been made in view of such a situation, and allows the operation amount to be reduced.

### Solutions to Problems

One aspect of the present technology is a sound source direction estimation device including: a first estimation unit configured to estimate a first horizontal angle that is a horizontal angle of a sound source direction from an input acoustic signal; and a second estimation unit configured to estimate a second horizontal angle that is the horizontal angle of the sound source direction and an elevation angle, with respect to the first horizontal angle, in a predetermined range near the first horizontal angle.

An input unit configured to input the acoustic signal from a microphone array including a plurality of microphones may further be provided

In the microphone array, the plurality of microphones may be arranged three-dimensionally.

The first estimation unit may perform an operation on a first spatial spectrum, and estimate the first horizontal angle on the basis of the first spatial spectrum.

The first estimation unit may include a first processing unit that performs an operation on the first spatial spectrum by a MUSIC method.

The second estimation unit may include a second processing unit that performs an operation on a second spatial spectrum by the MUSIC method.

The first estimation unit may further include a horizontal angle estimation unit configured to estimate the first horizontal angle on the basis of the first spatial spectrum on which the first processing unit performs an operation.

The second processing unit may perform an operation on the second spatial spectrum by the MUSIC method in a range of the entire elevation angle in a predetermined range of the horizontal angle near the first horizontal angle.

The first processing unit may include a first correlation matrix calculation unit that calculates a correlation matrix of a target sound signal of respective frequencies for every time frame of the acoustic signal for performing an operation on the first spatial spectrum.

The first processing unit may further include a second correlation matrix calculation unit that calculates a correlation matrix of a noise signal of respective frequencies for every time frame of the acoustic signal for performing an operation on the first spatial spectrum.

The second estimation unit may further include a detection unit that detects the sound source direction from a peak of the second spatial spectrum.

A presentation unit configured to present the sound source direction detected by the detection unit may further be provided.

The presentation unit may change a presentation state according to the estimated elevation angle.

The first processing unit may thin out the direction in which the first spatial spectrum is calculated. An operation may be performed on the first spatial spectrum in the thinned out direction by interpolation.

The second estimation unit may repeat processing of computing a range in which the second spatial spectrum is computed in a range limited in both the horizontal angle and the elevation angle, and detecting the peak of the computed second spatial spectrum until both the horizontal angle and the elevation angle no longer change.

The second estimation unit may include an SRP processing unit that processes a pair signal of one channel of the microphones arranged three-dimensionally and another one channel of the microphones.

The SRP processing unit may calculate a cross-correlation of a plurality of the pair signals. In the predetermined range near the first horizontal angle, the SRP processing unit may estimate the second horizontal angle and the elevation angle from a peak of the cross-correlation.

The first estimation unit may not estimate the first horizontal angle, and the SRP processing unit may estimate the second horizontal angle and the elevation angle from a peak of the cross-correlation.

One aspect of the present technology is a method of estimating a sound source direction to be executed by a sound source direction estimation device, the method including: a first step of estimating a first horizontal angle that is a horizontal angle of the sound source direction from an input acoustic signal; and a second step of estimating a second horizontal angle that is the horizontal angle of the sound source direction and an elevation angle, with respect to the first horizontal angle, in a predetermined range near the first horizontal angle.

One aspect of the present technology is a program for causing a computer to execute sound source direction estimation processing including: a first step of estimating a first horizontal angle that is a horizontal angle of the sound source direction from an input acoustic signal; and a second step of estimating a second horizontal angle that is the horizontal angle of the sound source direction and an elevation angle, with respect to the first horizontal angle, in a predetermined range near the first horizontal angle.

According to one aspect of the present technology, a first estimation unit estimates a first horizontal angle that is a horizontal angle of a sound source direction from an input acoustic signal, and a second estimation unit estimates a second horizontal angle that is the horizontal angle of the sound source direction and an elevation angle, with respect to the first horizontal angle, in a predetermined range near the first horizontal angle.

### Effects of the Invention

As described above, one aspect of the present technology makes it possible to reduce an operation amount for estimating a direction of a target sound source. Note that advantageous effects described here are not necessarily restrictive, and any of the effects described in the present specification may be applied.

### BRIEF DESCRIPTION OF DRAWINGS

FIG. 1 is a perspective view showing a configuration of one embodiment of a sound source direction estimation device.

FIG. 2 is a block diagram showing a configuration of a first embodiment of the sound source direction estimation device.

FIG. 3 is a diagram showing a configuration of a microphone array.

FIG. 4 is a diagram showing the configuration of the microphone array.

FIG. 5 is a diagram illustrating a time difference of arrival at a microphone.

FIG. 6 is a flowchart illustrating sound source direction estimation processing.

FIG. 7 is a diagram illustrating an estimation range.

FIG. 8 is a block diagram showing a configuration of a second embodiment of the sound source direction estimation device.

FIG. 9 is a flowchart illustrating the sound source direction estimation processing.

FIG. 10 is a block diagram showing a configuration of a third embodiment of the sound source direction estimation device.

FIG. 11 is a flowchart illustrating the sound source direction estimation processing.

FIG. 12 is a flowchart illustrating first MUSIC processing.

FIG. 13 is a flowchart illustrating horizontal angle estimation processing.

FIG. 14 is a flowchart illustrating second MUSIC processing.

FIG. 15 is a perspective view showing an example of display of the sound source direction estimation device.

FIG. 16 is a diagram illustrating thinning out processing.

FIG. 17 is a block diagram showing a configuration of a fifth embodiment of the sound source direction estimation device.

FIG. 18 is a flowchart illustrating peak detection processing.

FIG. 19 is a diagram illustrating the peak detection processing.

FIG. 20 is a diagram illustrating a pair of microphones.

FIG. 21 is a block diagram showing a configuration of a sixth embodiment of the sound source direction estimation device.

FIG. 22 is a flowchart illustrating the sound source direction estimation processing.

FIG. 23 is a block diagram showing a configuration of a seventh embodiment of the sound source direction estimation device.

FIG. 24 is a flowchart illustrating the sound source direction estimation processing.

FIG. 25 is a diagram illustrating a position of the sound source.

FIG. 26 is a diagram showing an example of a spatial spectrum.

FIG. 27 is a diagram showing an evaluation result.

FIG. 28 is a diagram illustrating an operation amount.

FIG. 29 is a block diagram showing a configuration example of a personal computer.

### MODE FOR CARRYING OUT THE INVENTION

Embodiments for carrying out the present technology will be described below. Note that the description will be made in the following order.

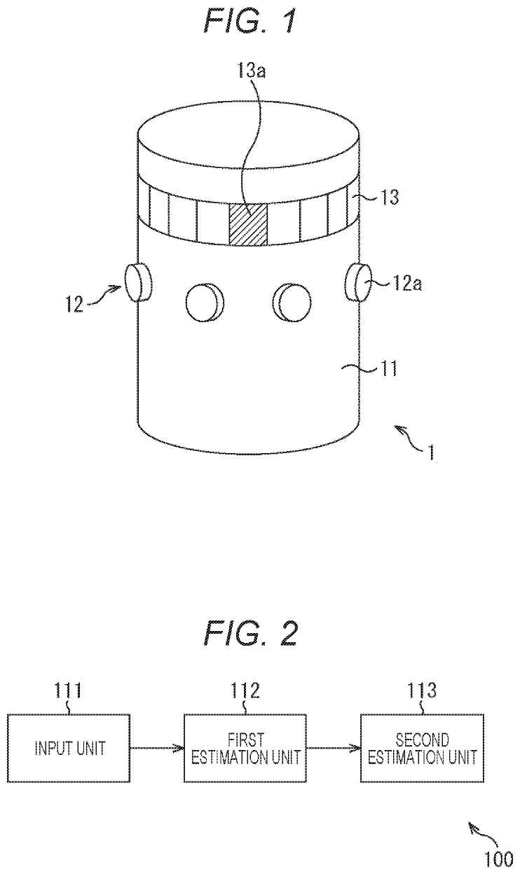

1. First embodiment (FIGS. 1 to 7)

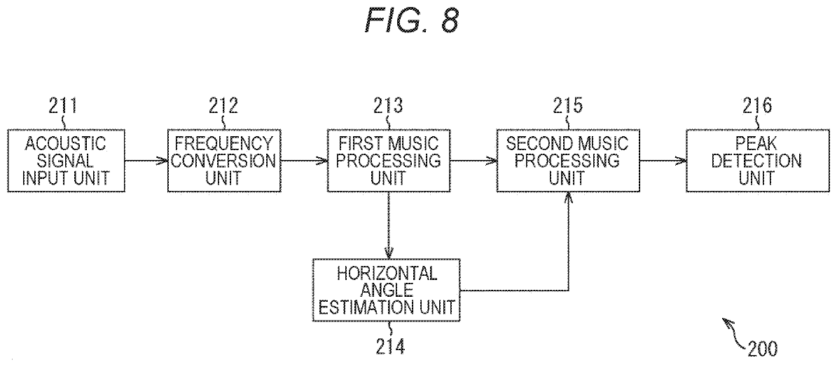

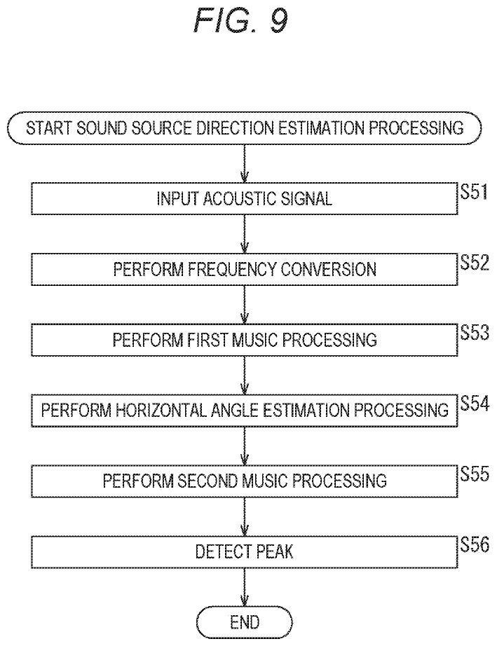

2. Second embodiment (FIGS. 8 and 9)

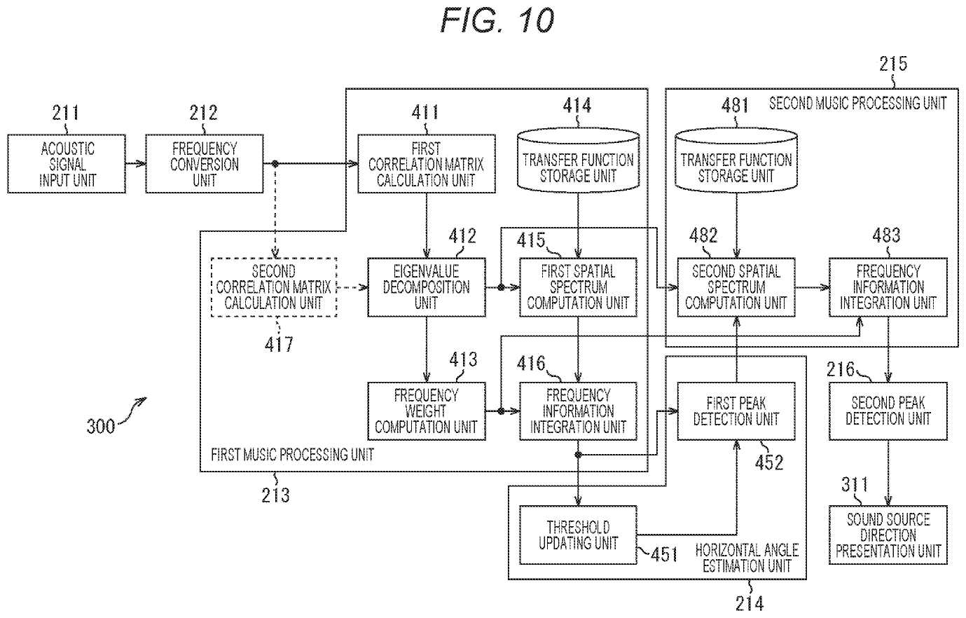

3. Third embodiment (FIGS. 10 to 15)

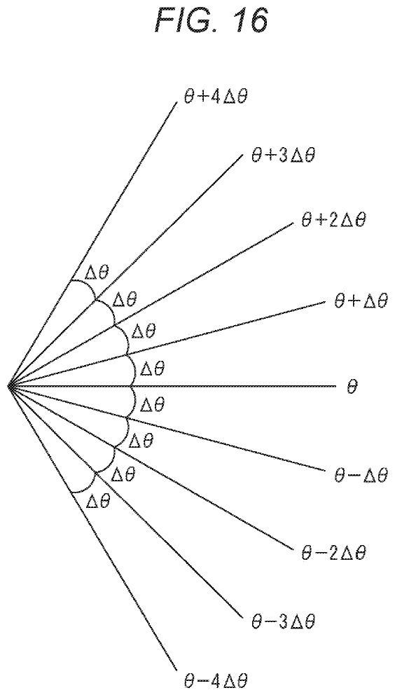

4. Fourth Embodiment (FIG. 16)

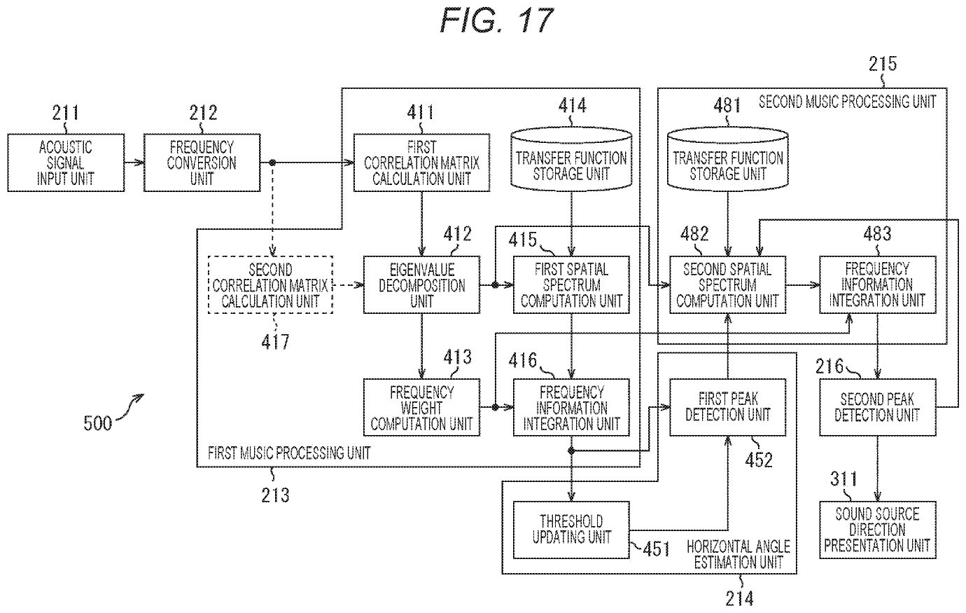

5. Fifth Embodiment (FIGS. 17 to 19)

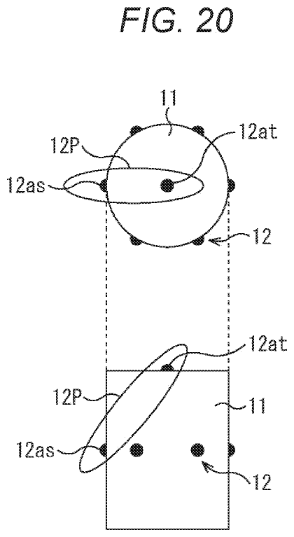

6. Sixth embodiment (FIGS. 20 to 22)

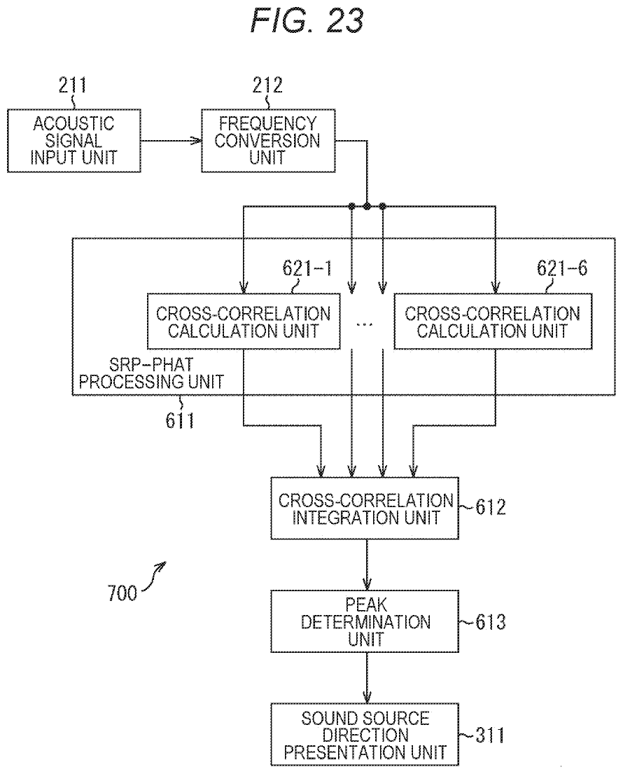

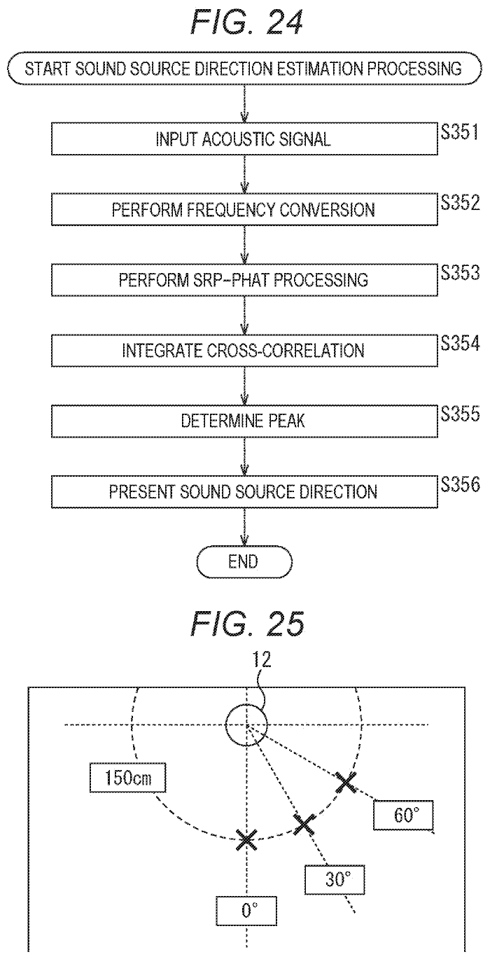

7. Seventh embodiment (FIGS. 23 and 24)

8. Experimental results (FIGS. 25 to 28)

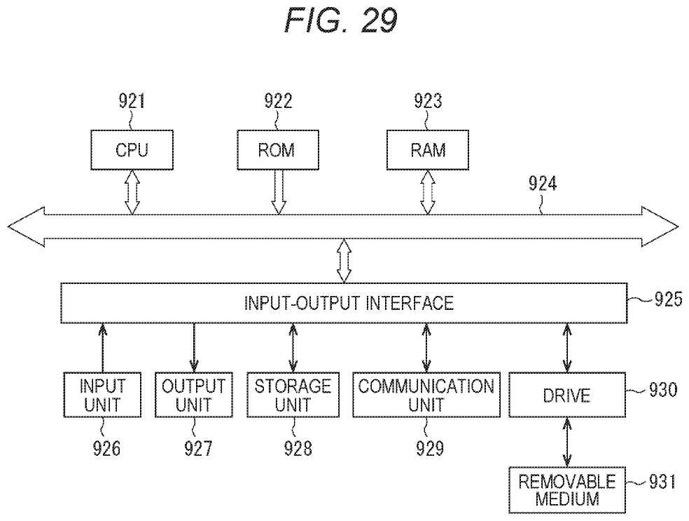

9. Computer (FIG. 29)

10. Other

### First Embodiment

(FIGS. 1 to 7)

First, with reference to FIGS. 1 to 7, the first embodiment will be described.

FIG. 1 is a perspective view showing a configuration of one embodiment of a sound source direction estimation device. The sound source direction estimation device 1 of this embodiment includes a substantially cylindrical housing 11, and a microphone array 12 is provided on an outer peripheral side surface thereof. The microphone array 12 includes a plurality of microphones 12a arranged in a substantially horizontal annular shape. A display unit 13 is provided on an outer peripheral side surface above the microphone array 12. The display unit 13 includes a plurality of LEDs 13a arranged in a substantially horizontal annular shape. The sound source direction estimation device 1 is mainly placed in an indoor environment.

The sound source direction estimation device 1 is installed in, for example, a smart speaker, a voice agent, a robot, and the like, and has a function of, in a case where a voice is uttered from a surrounding sound source (for example, a person), estimating a direction in which the voice is uttered. The estimated direction is used to present the sound source direction, for example, by causing the LED 13a in the corresponding direction to emit light. Hereinafter, an electric configuration of the sound source direction estimation device 1 will be described.

FIG. 2 is a block diagram showing a configuration of the first embodiment of the sound source direction estimation device. The electric configuration of the sound source direction estimation device 1 of FIG. 1 is shown in FIG. 2 as a sound source direction estimation device 100.

The sound source direction estimation device 100 includes an input unit 111, a first estimation unit 112, and a second estimation unit 113.

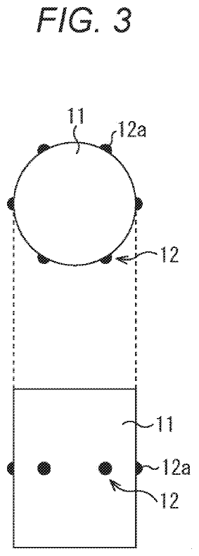

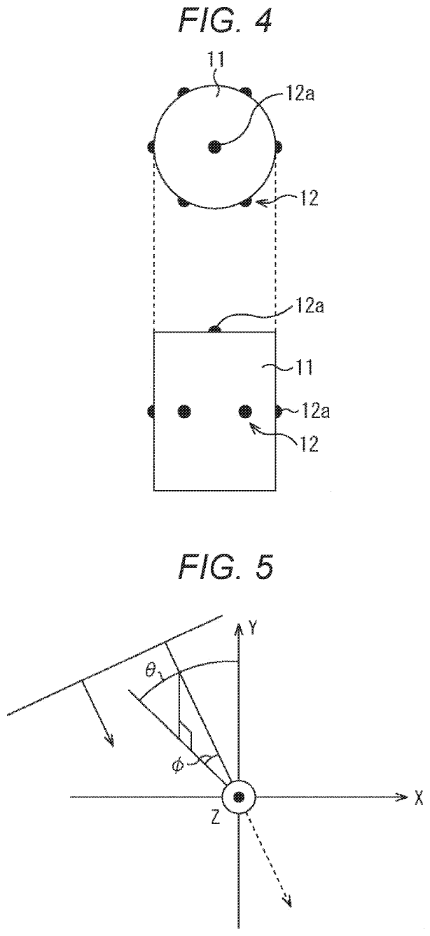

The input unit 111 corresponds to the microphone array 12 of FIG. 1. FIGS. 3 and 4 are diagrams showing a configuration of the microphone array. FIG. 3 shows a configuration similar to the configuration of FIG. 1. Six microphones 12a are arranged at equal intervals in a horizontal annular shape, that is, on a plane (two-dimensionally) at the substantial center of the circumferential side surface of the cylindrical housing 11. In the example of FIG. 4, in addition to the six microphones 12a arranged at the substantial center of the circumferential side surface of the cylindrical housing 11 in a similar manner to the case shown in FIG. 3, one microphone 12a is disposed at the center of an upper surface of the housing 11. That is, in the example of FIG. 4, a total of seven microphones 12a are arranged three-dimensionally (in a three-dimensional manner).

The microphones 12a may be arranged on a plane as shown in FIG. 3 if not linearly, but vertical arrangement, as shown in FIG. 4, enables more accurate estimation of the elevation angle.

FIG. 5 is a diagram illustrating a time difference of arrival at the microphone. In three-dimensional coordinates such as FIG. 5, the Y-axis direction is defined as a reference 0° for the horizontal angle θ with respect to the origin, and the XY plane (horizontal plane) is defined as a reference 0° for the elevation angle φ.

In this case, when the time at which a sound arriving from the direction (θ, φ) reaches the origin is 0 and the time at which the sound reaches the m-th microphone at the coordinates (Xₘ, Yₘ, Zₘ) is tₘ, the time tₘ can be determined by the following equation (1). Note that in equation (1), c represents the speed of sound.

$$\begin{matrix}[ Equation 1 ] & \\ {t}_{m} = \frac{( {X}_{m} sin θ - {Y}_{m} cos θ ) cos φ - {Z}_{m} sin φ}{c} & ( 1 )\end{matrix}$$

Therefore, an arrival time difference between the m-th microphone and the n-th microphone is expressed by the following equation (2).

$$\begin{matrix} [ Equation 2 ] & \\ Δ {t}_{m , n} = {t}_{m} - {t}_{n} = \frac{[ ( {X}_{m} - {X}_{n} ) sin θ - ( {Y}_{m} - {Y}_{n} ) cos θ ] cos φ - ( {Z}_{m} - {Z}_{n} ) sin φ}{c} & ( 2 )\end{matrix}$$

Direction estimation is performed on the basis of the time difference Δt_{m,n} expressed by equation (2). Therefore, if the sound source direction is estimated by detecting only the horizontal angle θ without detecting the elevation angle φ, in a case where the elevation angle φ is not 0, an error will occur. Therefore, in the present technology, not only the horizontal angle θ but also the elevation angle φ is detected.

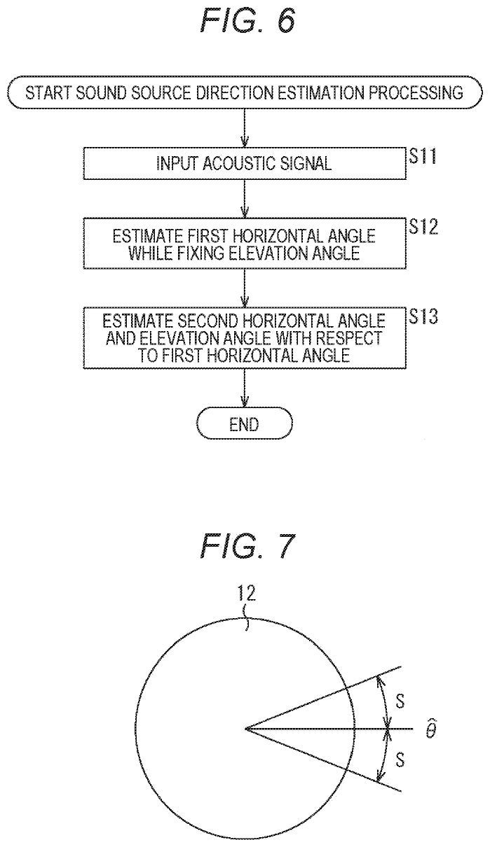

The first estimation unit 112 of FIG. 2 estimates the horizontal angle, and the second estimation unit 113 estimates the horizontal angle and the elevation angle. Next, an operation of the sound source direction estimation device 100 of FIG. 2 will be described with reference to FIG. 6. FIG. 6 is a flowchart illustrating sound source direction estimation processing.

In step S11, the input unit 111 inputs an acoustic signal. That is, the plurality of microphones 12a constituting the microphone array 12 collects a sound from a sound source in a predetermined direction and output a corresponding acoustic signal.

In step S12, the first estimation unit 112 estimates a first horizontal angle while fixing the elevation angle. That is, the elevation angle φ is fixed at a predetermined angle (for example, 0 degrees). Then, a predetermined horizontal angle among the horizontal angles θ in the 360-degree direction in the horizontal plane is estimated as the first horizontal angle θ\hat{ } representing the sound source direction. As described with reference to FIG. 5, the timing at which each microphone 12a collects a sound differs depending on the direction of the sound source. Using this time difference, the horizontal angle of the sound source direction is estimated.

In step S13, the second estimation unit 113 estimates a second horizontal angle and the elevation angle with respect to the first horizontal angle θ\hat{ }. That is, with respect to the first horizontal angle θ\hat{ } estimated in the processing of step S12 the horizontal angle and the elevation angle are estimated only in a predetermined range (θ\hat{ }±s) near the first horizontal angle θ\hat{ }. The first horizontal angle θ\hat{ }, which is estimated in a state where the elevation angle is fixed at a predetermined value (that is, in a state where it is assumed that the sound source exists at an elevation angle different from the actual elevation angle), is not always accurate and contains an error. Therefore, in this step, together with the actual elevation angle of the sound source, the second horizontal angle θ^{out} is estimated as a more accurate horizontal angle of the sound source.

FIG. 7 is a diagram illustrating an estimation range. As shown in FIG. 7, the range in which the elevation angle is estimated is not the range of the entire horizontal angle of 360 degrees, but the limited range near the primarily estimated first horizontal angle θ\hat{ } (θ\hat{ }±s). Therefore, the operation amount can be reduced. As a result, even a device whose operation resource is not high (operation capability is not high) can perform the operation in real time. The present technology can be applied to even conditions where the direction in which the user is likely to exist is completely unknown (in a case where there is no information indicating that the user is within the angle of view of the camera and the like or “the user is in this direction” in advance like a wearable device).

### Second Embodiment

(FIGS. 8 and 9)

Next, the second embodiment will be described with reference to FIGS. 8 and 9. FIG. 8 is a block diagram showing a configuration of the second embodiment of the sound source direction estimation device. In FIG. 8, an electric configuration of the sound source direction estimation device 1 of FIG. 1 is shown as a sound source direction estimation device 200.

The sound source direction estimation device 200 includes an acoustic signal input unit 211, a frequency conversion unit 212, a first MUSIC processing unit 213, a horizontal angle estimation unit 214, a second MUSIC processing unit 215, and a peak detection unit 216. In this embodiment, a multiple signal classification (MUSIC) method is used for estimation processing.

The acoustic signal input unit 211 and the frequency conversion unit 212 correspond to the input unit 111 of FIG. 2. The first MUSIC processing unit 213 and the horizontal angle estimation unit 214 correspond to the first estimation unit 112 of FIG. 2. Moreover, the second MUSIC processing unit 215 and the peak detection unit 216 correspond to the second estimation unit 113 of FIG. 2.

The acoustic signal input unit 211 corresponds to the microphone array 12 of FIG. 1, collects sounds from surrounding sound sources, and outputs a corresponding acoustic signal.

The frequency conversion unit 212 performs frequency conversion on the acoustic signal input from the acoustic signal input unit 211. On the basis of a frequency domain signal input from the frequency conversion unit 212, the first MUSIC processing unit 213 determines an eigenvalue and an eigenvector of a correlation matrix of the signal of respective frequencies. Moreover, the first MUSIC processing unit 213 performs an operation on a spatial spectrum at the entire horizontal angle in a state where the elevation angle with respect to the sound source direction viewed from the sound source direction estimation device 200 is fixed at a predetermined constant value.

The horizontal angle estimation unit 214 calculates a threshold from the spatial spectrum on which an operation is performed by the first MUSIC processing unit 213, detects the spatial spectrum having a peak value exceeding the threshold, and estimates and detects the direction corresponding to the spatial spectrum as the sound source direction (first horizontal angle θ\hat{ }).

With respect to the first horizontal angle θ\hat{ } estimated by the horizontal angle estimation unit 214, the second MUSIC processing unit 215 computes the spatial spectrum of the horizontal angle in a limited predetermined range near the first horizontal angle θ\hat{ } and the entire elevation angle on the basis of the eigenvector of the correlation matrix of the signal of respective frequencies determined by the first MUSIC processing unit 213.

The peak detection unit 216 detects the peak value of the spatial spectrum for the horizontal angle and the elevation angle within the predetermined range computed by the second MUSIC processing unit 215, and estimates the direction corresponding to the peak value as the final sound source direction (θ^{out}, (φ^{out}).

An operation of the sound source direction estimation device 200 will be described with reference to FIG. 9. FIG. 9 is a flowchart illustrating the sound source direction estimation processing.

In step S51, the acoustic signal input unit 211 inputs an acoustic signal. That is, for example, the plurality of microphones 12a constituting the microphone array 12 arranged as shown in FIG. 3 or 4 collects a sound from a sound source in a predetermined direction and outputs a corresponding acoustic signal. This processing is similar to the processing of step S11 in FIG. 6.

In step S52, the frequency conversion unit 212 performs frequency conversion on the acoustic signal input from the acoustic signal input unit 211. That is, the acoustic signal is converted from a signal of a time-base domain to a signal of a frequency domain. For example, discrete Fourier transform (DFT) or short time Fourier transform (STFT) processing is performed for every frame. For example, a frame length can be 32 ms and a frame shift can be 10 ms.

In step S53, the first MUSIC processing unit 213 performs first MUSIC processing. Specifically, the frequency domain signal is input from the frequency conversion unit 212, and processing is performed by the MUSIC method for the entire horizontal angle with the elevation angle fixed at a certain value. An operation is performed on the eigenvalue and the eigenvector of the correlation matrix of the signal, and the spatial spectrum is calculated. Weighted averaging is performed on the spatial spectrum between frequencies.

In step S54, the horizontal angle estimation unit 214 performs horizontal angle estimation processing. Specifically, the threshold is calculated from the spatial spectrum determined by the first MUSIC processing unit 213, and the direction having the peak exceeding the threshold is set as the estimated horizontal angle (first horizontal angle θ\hat{ }).

In step S55, the second MUSIC processing unit 215 performs second MUSIC processing. Specifically, the eigenvector determined by the first MUSIC processing unit 213 and the horizontal angle estimated by the horizontal angle estimation unit 214 (first horizontal angle θ\hat{ }) are input. Then, the spatial spectrum is calculated by the MUSIC method for the horizontal angle in the range limited to the first horizontal angle θ\hat{ }±s and the entire elevation angle. That is, the horizontal angle and the elevation angle are estimated in the limited range (θ\hat{ }±s) near the primarily estimated first horizontal angle θ\hat{ }. Weighted averaging is performed on the spatial spectrum between frequencies.

In step S56, the peak detection unit 216 detects the peak value. Specifically, the spatial spectrum having the maximum value (peak) is detected from among the spatial spectra subjected to weighted averaging output from the second MUSIC processing unit 215. Then, the horizontal angle (second horizontal angle θ^{out}) and the elevation angle φ^{out} corresponding to the spatial spectrum are output as the sound source direction (θ^{out}, φ^{out}).

In the second embodiment, since the operation by the MUSIC method is performed, the sound source direction can be accurately determined. Furthermore, in a similar manner to the first embodiment, the range in which the elevation angle is estimated is not the range of the entire horizontal angle of 360 degrees, but the limited range near the primarily estimated first horizontal angle θ\hat{ }(θ\hat{ }±s). Therefore, the operation amount can be reduced. As a result, even a device whose operation resource is not high (operation capability is not high) can perform the operation in real time.

### Third Embodiment

(FIGS. 10 to 15)

Next, the third embodiment will be described with reference to FIGS. 10 to 15. FIG. 10 is a block diagram showing a configuration of the third embodiment of the sound source direction estimation device. In FIG. 10, an electric configuration of the sound source direction estimation device 1 of FIG. 1 is shown as a sound source direction estimation device 300.

The sound source direction estimation device 300 of FIG. 10 includes an acoustic signal input unit 211, a frequency conversion unit 212, a first MUSIC processing unit 213, a horizontal angle estimation unit 214, a second MUSIC processing unit 215, a second peak detection unit 216, and a sound source direction presentation unit 311. The acoustic signal input unit 211, the frequency conversion unit 212, the first MUSIC processing unit 213, the horizontal angle estimation unit 214, and the second MUSIC processing unit 215 in FIG. 10 have functions similar to functions of components having corresponding names in FIG. 8. Furthermore, the second peak detection unit 216, which has a different name, corresponds to the peak detection unit 216 of FIG. 8 and has a similar function.

The first MUSIC processing unit 213 of FIG. 10 includes a first correlation matrix calculation unit 411, an eigenvalue decomposition unit 412, a frequency weight computation unit 413, a transfer function storage unit 414, and a first spatial spectrum computation unit 415. Moreover, the first MUSIC processing unit 213 includes a frequency information integration unit 416 and a second correlation matrix calculation unit 417. However, this configuration is used in a case where GEVD-MUSIC is used. In a case where SEVD-MUSIC is used, the second correlation matrix calculation unit 417 is omitted. GEVD means generalized eigenvalue decomposition, and SEVD means standard eigenvalue decomposition.

The first correlation matrix calculation unit 411 calculates a correlation matrix of a target signal of respective frequencies for every time frame. The second correlation matrix calculation unit 417 calculates a correlation matrix of a noise signal of respective frequencies for every time frame. The eigenvalue decomposition unit 412 performs an operation on an eigenvalue and an eigenvector of the correlation matrix. The frequency weight computation unit 413 computes a frequency weight representing the degree of contribution of a spatial spectrum for each frequency. In a case where a sound arrives from a certain direction, an imbalance is created in distribution of the eigenvalue, and only the eigenvalue of the number of sound sources becomes large.

The transfer function storage unit 414 stores a transfer function vector in advance. The first spatial spectrum computation unit 415 uses the eigenvector and the transfer function vector relating to the horizontal angle θ to compute a spatial spectrum indicating the degree of sound arrival from the direction of the horizontal angle θ. The frequency information integration unit 416 integrates the first spatial spectrum on the basis of the frequency weight.

The horizontal angle estimation unit 214 includes a threshold updating unit 451 and a first peak detection unit 452. The threshold updating unit 451 calculates a threshold for determining whether or not to employ a peak of the spatial spectrum as a detection result. The first peak detection unit 452 detects the direction of the spatial spectrum having a peak exceeding the threshold.

The second MUSIC processing unit 215 includes a transfer function storage unit 481, a second spatial spectrum computation unit 482, and a frequency information integration unit 483. The transfer function storage unit 481 stores the transfer function vector in advance. The second spatial spectrum computation unit 482 computes the spatial spectrum indicating the degree of sound arrival from the direction of the predetermined horizontal angle and the elevation angle. The frequency information integration unit 483 computes the weighted average of the spatial spectrum for each frequency.

The sound source direction presentation unit 311 presents the estimated sound source direction to a user.

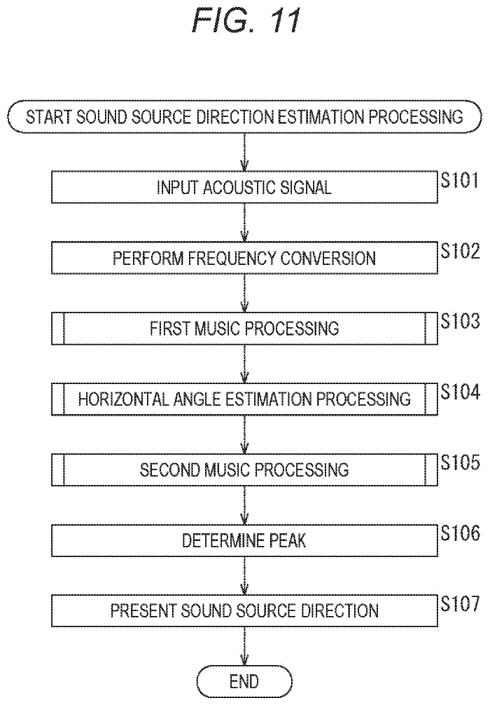

Next, an operation of the sound source direction estimation device 300 of FIG. 10 will be described with reference to FIG. 11. FIG. 11 is a flowchart illustrating the sound source direction estimation processing.

In step S101, the acoustic signal input unit 211 inputs an acoustic signal collected by the microphone array 12. In step S102, the frequency conversion unit 212 performs frequency conversion on the acoustic signal input from the acoustic signal input unit 211. Processing in steps S101 and S102 is similar to processing in steps S51 and S52 of FIG. 9, respectively, and thus repeated details will be omitted.

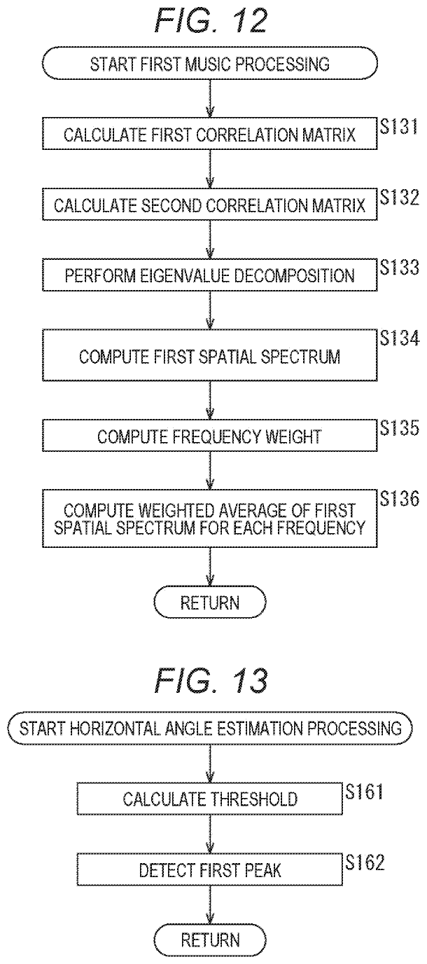

In step S103, the first MUSIC processing unit 213 performs first MUSIC processing. Details of the first MUSIC processing are shown in FIG. 12. FIG. 12 is a flowchart illustrating the first MUSIC processing.

In step S131 of FIG. 12, the first correlation matrix calculation unit 411 calculates a first correlation matrix. The first correlation matrix is a correlation matrix of a target sound signal of respective frequencies for every time frame, and each element thereof represents a correlation of each microphone 12a. An operation is performed on the first correlation matrix on the basis of the following equation (3). In equation (3), T_{R} represents a frame length for calculating the correlation matrix, and a vector z_{ω, τ} represents a signal of a frequency ω in a time frame τ. H represents Hermite transposition.

$$\begin{matrix}[ Equation 3 ] & \\ {R}_{ω , t} = \frac{1}{{T}_{R}} {\sum }_{τ = t - {T}_{R}}^{t} {z}_{ω , τ} {z}_{ω , τ}^{H} & ( 3 )\end{matrix}$$

In step S132, the second correlation matrix calculation unit 417 calculates a second correlation matrix. The second correlation matrix is a correlation matrix of a noise signal of respective frequencies for every time frame, and is calculated on the basis of the following equation (4).

$$\begin{matrix}[ Equation 4 ] & \\ {K}_{ω , t} = \frac{1}{{T}_{K}} {\sum }_{τ = t - Δ t - {T}_{K}}^{t - Δ t} {α}_{ω , τ} {z}_{ω , τ} {z}_{ω , τ}^{H} & ( 4 )\end{matrix}$$

In equation (4), T_{K} represents a frame length for calculating the correlation matrix, and Δt is used such that a signal of a time frame common to R_{ω, t} of equation (3) and K_{ω, t} of equation (4) is not used. α_{ω, τ} is a weight and may be generally 1, but in a case where it is desired to change the weight depending on the type of sound source, it is possible to prevent all the weights from becoming zero as in equation (5).

[Equation 5]

K_{ω,t}=(1−α_{ω,t})K_{ω,t-1}+α_{ω,t}z_{ω,t-Δt}z_{ω,t-Δt}^{H} (5)

According to equation (5), the second correlation matrix calculation unit 417 sequentially updates a second spatial correlation matrix to which a weight has been applied, which is subjected to generalized eigenvalue decomposition by the eigenvalue decomposition unit 412 in the subsequent stage, on the basis of the second spatial correlation matrix to which a past weight has been applied. Such an updating equation makes it possible to use a stationary noise component for a long time. Moreover, in a case where the weight is a continuous value from 0 to 1, as the second space correlation matrix is calculated in more past, the number of times of weight integration increases and the weight becomes smaller, and thus larger weight is applied as the stationary noise component is generated at later time. Therefore, with the larger weight applied to the stationary noise component at the most recent time, which is considered to be close to the stationary noise component behind the target sound, the calculation of the second spatial correlation matrix becomes possible.

In step S133, the eigenvalue decomposition unit 412 performs eigenvalue decomposition. That is, the eigenvalue decomposition unit 412 performs generalized eigenvalue decomposition based on the weighted second spatial correlation matrix supplied from the second correlation matrix calculation unit 417, and a first spatial correlation matrix supplied from the first correlation matrix calculation unit 411. Then, the eigenvalue and the eigenvector are calculated from the following equation (6).

[Equation 6]

R_{ω,t}e_{ω,t,i}=λ_{ω,t,i}K_{ω,t}e_{ω,t,i} (6)

(i=1 . . . , M)

In equation (6), λᵢ represents the i-th largest eigenvalue vector determined by generalized eigenvalue decomposition, eᵢ represents an eigenvector corresponding to λᵢ, and M represents the number of microphones 12a.

In a case where SEVD is used, K_{ω, t} has the same value as in equation (7).

[Equation 7]

K_{ω,t}=I (7)

In a case where GEVD is used, equation (6) is transformed as expressed by equations (9) and (10) by using a matrix Φ_{ω, t} satisfying the following equation (8). This will lead to a problem of SEVD, and the eigenvalue and the eigenvector are determined from equations (9) and (10).

[Equation 8]

ϕ_{ω,t}^{H}ϕ_{ω,t}=K_{ω,t} (8)

(ϕ_{ω,t}^{-H}R_{ω,t}ϕ_{ω,t}⁻¹)f_{ω,t,i}=λ_{ω,t,i}f_{ω,t,i} (9)

f_{ω,t,i}=ϕ_{ω,t}e_{ω,t,i} (10)

Φ^{-H}_{ω, t} of equation (9) is a whitening matrix. A part in the parenthesis on the left side of equation (9) is obtained by whitening R_{ω, t} by the stationary noise component, that is, obtained by removing the stationary noise component.

In step S134, the first spatial spectrum computation unit 415 computes the first spatial spectrum Pⁿ_{ω, θ, t} on the basis of the following equations (11) and (12). That is, the first spatial spectrum computation unit 415 computes the spatial spectrum Pⁿ_{ω, θ, t} representing the degree of sound arrival from the direction θ by using the eigenvector eᵢ corresponding to the M-N eigenvalues from the smallest one and a steering vector a_{θ}. The eigenvector eᵢ is supplied from the eigenvalue decomposition unit 412. The steering vector a_{θ}, which is a transfer function regarding the direction θ, is a transfer function obtained in advance assuming that there is a sound source in the direction θ, and is stored in advance in the transfer function storage unit 414.

$$\begin{matrix}[ Equation 9 ] & \\ {P}_{ω , θ , t}^{n} = \frac{{a}_{ω , θ}^{H} {φ}_{ω , t}^{- 1} {φ}_{ω , t}^{- H} {a}_{ω , θ}}{{a}_{ω , θ}^{H} {φ}_{ω , t}^{- 1} {F}_{ω , t}^{n} {F}_{ω , t}^{nH} {φ}_{ω , t}^{- H} {a}_{ω , θ}} & ( 11 ) \\ {F}_{ω , t}^{n} = [ {f}_{ω , t , N + 1} , … , {f}_{ω , t , M} ] & ( 12 )\end{matrix}$$

N represents the number of sound sources, and θ represents the horizontal direction for calculating the spatial spectrum while the elevation angle is fixed.

In step S135, the frequency weight computation unit 413 computes a frequency weight representing the degree of contribution of the spatial spectrum for each frequency. In a case where a sound is arriving from a certain direction, an imbalance is created in distribution of the eigenvalue, and only the eigenvalue of the number of sound sources becomes large. For example, the frequency weight w_{ω, t} is calculated by the following equation (13). λᵢ is the i-th largest eigenvalue obtained by generalized eigenvalue decomposition, and the eigenvalue of the numerator in equation (13) means the largest eigenvalue.

$$\begin{matrix}[ Equation 10 ] & \\ {W}_{ω , t} = \frac{{λ}_{ω , t , 1}}{{\sum }_{m = 1}^{M} {λ}_{ω , t , m}} ( i = 1 , … , M ) & ( 13 )\end{matrix}$$

In step S136, the frequency information integration unit 416 computes the weighted average P⁻ⁿ_{θ, t} of the first spatial spectrum for each frequency by the following equations (14) and (15). The first spatial spectrum Pⁿ_{ω, θ, t} is supplied from the first spatial spectrum computation unit 415, and the frequency weight w_{ω, t} is supplied from the frequency weight computation unit 413.

$$\begin{matrix}[ Equation 11 ] & \\ {\overline{P}}_{θ , t}^{n} = \frac{{\sum }_{{ω}^{{W}_{ω , t}}}}{{\sum }_{ω} \frac{{W}_{ω , t}}{{P}_{ω , θ , t}^{n}}} & ( 14 ) \\ {\hat{P}}_{θ , t}^{n} = log {\overline{P}}_{θ , t}^{n} - {min}_{{θ}^{′}} log {\overline{P}}_{{θ}^{′} , t}^{n} & ( 15 )\end{matrix}$$

Note that the second term in equation (15) is to minimize log P⁻ⁿ_{θ′, t} in equation (15) when θ′ is changed in the entire range of the horizontal direction θ in which the spatial spectrum is calculated with the elevation angle fixed.

Although the harmonic mean is determined in the operation of equation (14), the arithmetic mean or the geometric mean may be determined. By the operation of equation (15), the minimum value is normalized to 0. The log base in this operation is arbitrary, but for example, Napier's constant can be used. The operation by equation (15) produces an effect of suppressing the peak irrelevant to the sound source to the threshold or less in the first peak detection unit 452 in the subsequent stage.

As described above, the weighted average P\hat{ }ⁿ_{θ, t} of the first spatial spectrum is calculated by the first MUSIC processing by the first MUSIC processing unit 213.

Returning to FIG. 11, after the first MUSIC processing (processing of FIG. 12) in step S103, horizontal angle estimation processing is performed by the horizontal angle estimation unit 214 in step S104. The horizontal angle estimation processing will be described with reference to FIG. 13. FIG. 13 is a flowchart illustrating the horizontal angle estimation processing.

In step S161, the threshold updating unit 451 calculates the threshold. That is, out of the weighted average P\hat{ }ⁿ_{θ, t} of the first spatial spectrum output from the frequency information integration unit 416 of the first MUSIC processing unit 213, a threshold P^{th}_{θ, t} for determining whether or not to perform peak detection is calculated by, for example, the following equations (16) and (17). α^{th}, β^{th}, and γ^{th} are each constants, and Θ represents the number of scanning directions.

$$\begin{matrix}[ Equation 12 ] & \\ {P}_{θ , t}^{th} = {β}^{th} {D}_{θ , t}^{th} + max [ {γ}^{t h} , \frac{1}{θ} {\sum }_{{θ}^{′} = 1}^{θ} {\hat{P}}_{{θ}^{′} , t}^{n} ] & ( 16 ) \\ {D}_{θ , t}^{th} = ( 1 - {α}^{th} ) {D}_{θ , t - 1}^{th} + {α}^{th} {\hat{P}}_{θ , t}^{n} & ( 17 )\end{matrix}$$

This threshold value P^{th}_{θ, t} produces an effect of removing a sound source that is not in that direction but has a small peak value, or removing a sound that continues to ring from a certain direction. The target voice is often a short command or utterance for manipulating a device, and is assumed not to last for a long time.

Next, in step S162, the first peak detection unit 452 detects a first peak. That is, out of the weighted average P\hat{ }ⁿ_{θ, t} of the first spatial spectrum output from the frequency information integration unit 416, those having a peak exceeding the threshold value P^{th}_{θ, t} output from the threshold value updating unit 451 are detected. Then, the horizontal angle θ\hat{ } corresponding to the weighted average P\hat{ }ⁿ_{θ, t} of the first spatial spectrum having the detected peak is output as the sound source direction (first horizontal angle) when the elevation angle is fixed.

As described above, the first horizontal angle θ\hat{ }, which is the sound source direction when the elevation angle is fixed, is estimated by the horizontal angle estimation processing by the horizontal angle estimation unit 214 in step S104 of FIG. 11 (processing of FIG. 13).

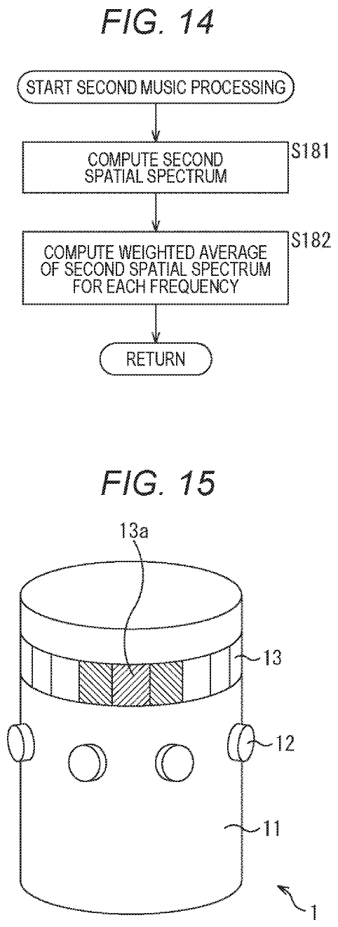

Next to the horizontal angle estimation processing in step S104 of FIG. 11, the second MUSIC processing is performed by the second MUSIC processing unit 215 in step S105. Details of the second MUSIC processing will be described with reference to FIG. 14. FIG. 14 is a flowchart illustrating the second MUSIC processing.

In step S181, the second spatial spectrum computation unit 482 computes a second spatial spectrum. That is, the second spatial spectrum is computed by using the eigenvector eᵢ corresponding to the M-N eigenvalue λᵢ from the smaller one out of the eigenvector eᵢ obtained by the eigenvalue decomposition unit 412, and the steering vector a_{θ˜, φ} which is the transfer function for the direction (θ˜, φ). The computation of the second spatial spectrum Pⁿ_{ω, θ, t} is performed, for example, by the following equation (18).

$$\begin{matrix}[ Equation 13 ] & \\ {P}_{ω , \tilde{θ} , φ , t}^{n} = \frac{{a}_{ω , \tilde{θ} , φ}^{H} {φ}_{ω , t}^{- 1} {φ}_{ω , t}^{- H} {a}_{ω , \tilde{θ} , φ}}{{a}_{ω , \tilde{θ} , φ}^{H} {φ}_{ω , t}^{- 1} {F}_{ω , t}^{n} {F}_{ω , t}^{nH} {φ}_{ω , t}^{- H} {a}_{ω , \tilde{θ} , φ}} & ( 18 )\end{matrix}$$

θ˜ is, with respect to the estimated direction θ\hat{ } of the sound source when the elevation angle is fixed, a limited range (θ\hat{ }±s) near the estimated direction θ\hat{ }. That is, θ\hat{ }−s<θ˜<θ\hat{ }+s. That is, the range for estimating the elevation angle is not the range of the entire horizontal angle of 360 degrees, but the limited range near the primarily estimated first horizontal angle θ\hat{ }. Φ represents the direction of the elevation angle for calculating the spatial spectrum.

The second spatial spectrum is a spatial spectrum representing the degree of sound arrival from the direction (θ˜, φ). The steering vector a_{θ˜, φ} for the direction (θ˜, φ) is stored in advance in the transfer function storage unit 481. The eigenvector eᵢ is supplied from the eigenvalue decomposition unit 412 of the first MUSIC processing unit 213.

In step S182, the frequency information integration unit 483 computes a weighted average P\hat{ }ⁿ_{θ˜, φ, t} of the second spatial spectrum for each frequency by the following equations (19) and (20). The second spatial spectrum P ⁿ_{θ˜, φ, t} is supplied from the second spatial spectrum computation unit 482. The frequency weight w_{ω, t} is supplied from the frequency weight computation unit 413 of the first MUSIC processing unit 213.

$$\begin{matrix}[ Equation 14 ] & \\ {\overline{P}}_{\tilde{θ} , φ , t}^{n} = \frac{{\sum }_{{ω}^{{W}_{ω , t}}}}{{\sum }_{ω} \frac{{W}_{ω , t}}{{P}_{ω , \tilde{θ} , φ , t}^{n}}} & ( 19 ) \\ {\hat{P}}_{\tilde{θ} , φ , t}^{n} = log {\overline{P}}_{\tilde{θ} , φ , t}^{n} - {min}_{{\tilde{θ}}^{′} , φ} log {\overline{P}}_{{\tilde{θ}}^{′} , φ , t}^{n} & ( 20 )\end{matrix}$$

By the above second MUSIC processing of the second MUSIC processing unit 215, the weighted average P\hat{ }ⁿ_{θ˜, φ, t} of the second spatial spectrum for each frequency is computed.

Returning to FIG. 11, when the second MUSIC processing of step S105 is finished, the second peak detection unit 216 detects the peak in step S106. That is, out of the weighted averaged spatial spectra output by the second MUSIC processing unit 215, the spatial spectrum having the maximum value is detected, and the horizontal angle (second horizontal angle θ^{out}) and the elevation angle φ^{out} corresponding to the spatial spectrum are output as the sound source direction (θ^{out}, φ^{out}). This processing is similar to the processing in step S56 of FIG. 9.

In step S107, the sound source direction presentation unit 311 presents the sound source direction. That is, the sound source direction detected in step S106 is presented. For example, out of the LEDs 13a constituting the display unit 13 of FIG. 1, the LED 13a corresponding to the sound source direction is turned on. This indicates that the voice from that direction is being received.

The three-dimensional sound source direction estimation makes it easy to estimate the accurate direction, but in a case where the elevation angle is large, the accuracy tends to be harder to obtain than in a case where the sound source exists on the same horizontal plane. Therefore, the display state can be changed depending on whether the estimated elevation angle is small or large.

For example, in a case where the estimated direction is presented with the LED, the presentation state can be changed, for example, by changing the way of illuminating the LED when the elevation angle is large or small. In a case where the estimated elevation angle is small (height is the same as or close to the plane on which the microphone array 12 exists), the illumination width of the LED 13a can be reduced. In a case where the elevation angle is large, the illumination width can be increased. For example, in a case where the width is reduced, only one LED 13a can be turned on as shown in FIG. 1, and in a case where the width is increased, as shown in FIG. 15, three LEDs 13a can be turned on. The number (width) of LEDs to be turned on corresponds to the magnitude of the elevation angle. The width may be changed not in the horizontal direction but in the vertical direction. Moreover, both the horizontal and vertical widths can be changed according to both the horizontal angle and the elevation angle.

Moreover, the color of the LED 13a can be changed. For example, in a case where the elevation angle is small, the LED 13a may have white to blue base color, and in a case where the elevation angle is large, the LED 13a may have yellow to red base color.

In this way, by indicating the lighting width or color, it is possible to notify the user of a fact that the direction of the sound source may be difficult to estimate.

Furthermore, in a case where there is a front surface or a part corresponding to the face of the housing 11, by rotating the face (housing 11) to be directed to the estimated direction of the sound source, it is possible to show that the voice from that direction is being received.

The third embodiment can also produce an effect similar to the effect of the second embodiment. That is, since the operation by the MUSIC method is performed, the sound source direction can be accurately determined. Furthermore, the range in which the horizontal angle and the elevation angle are estimated is not the range of the entire horizontal angle of 360 degrees, but the limited range near the primarily estimated first horizontal angle θ\hat{ } (θ\hat{ }±s). Therefore, the operation amount can be reduced. As a result, even a device whose operation resource is not high (operation capability is not high) can perform the operation in real time.

Moreover, in the third embodiment, since the sound source direction is presented, it is possible to inform the user of the estimated sound source direction.

### Fourth Embodiment

(FIG. 16)

Next, the fourth embodiment will be described. The block diagram of the fourth embodiment is similar to the block diagram shown in FIG. 10, and thus illustration thereof is omitted.

In the fourth embodiment, an operation amount is further reduced by devising processing in a first spatial spectrum computation unit 415. An example thereof will be described with reference to FIG. 16. FIG. 16 is a diagram illustrating thinning out processing.

In the example of FIG. 16, a direction in which a spatial spectrum is computed is thinned out by the first spatial spectrum computation unit 415. Then, the spatial spectrum in the thinned out direction is estimated by quadratic interpolation.

In a case where the number of directions to be thinned out when computing the spatial spectrum is one, that is, in a case where the spatial spectra are computed in the directions (horizontal angle) of θ, θ±2Δθ, θ±4Δθ, . . . , in FIG. 16, the spatial spectra in the thinned out directions θ±Δθ, θ±3Δθ, . . . therebetween are interpolated. For example, the spatial spectrum at the horizontal angle θ+Δθ is interpolated by the following equation (21).

[Equation 15]

P_{ω,θ+θ,t}ⁿ=−⅛P_{ω,θ-2Δθ,t}ⁿ+¾P_{ω,θ,t}ⁿ+⅜P_{ω,θ+2Δθ,t}ⁿ (21)

Similarly, in a case where the number of directions to be thinned out when computing the spatial spectrum is two, that is, in a case where the spatial spectra are computed in the directions of θ, θ±3Δθ, θ±6Δθ, . . . , in FIG. 16, the spatial spectra in the thinned out directions θ±Δθ, θ±2Δθ, . . . therebetween are interpolated. For example, the spatial spectra in the directions θ+Δθ and θ+2Δθ are interpolated by the following equations (22) and (23).

[Equation 16]

P_{ω,θ+Δθ,t}ⁿ=− 1/9P_{ω,θ-3Δθ,t}ⁿ+ 8/9P_{ω,θ,t}ⁿ+ 2/9P_{ω,θ+3Δθ,t}ⁿ (22)

P_{ω,θ+Δθ,t}ⁿ=− 1/9P_{ω,θ-3Δθ,t}ⁿ+ 5/9P_{ω,θ,t}ⁿ+ 5/9P_{ω,θ+3Δθ,t}ⁿ (23)

Moreover, in a case where the number of directions to be thinned out when computing the spatial spectrum is three, that is, in a case where the spatial spectra are computed at the horizontal angles θ, θ±4Δθ, θ±8Δθ, . . . , in FIG. 16, the spatial spectra at the horizontal angles θ±Δθ, θ±2Δθ, θ±3Δθ, . . . therebetween are interpolated. For example, the spatial spectra at the horizontal angles θ+Δθ, θ+2Δθ, θ+3Δθ are interpolated by the following equations (24) to (26).

[Equation 17]

P_{ω,θ+Δθ,t}ⁿ=− 3/32P_{ω,θ-4Δθ,t}ⁿ+ 15/16P_{ω,θ,t}ⁿ+ 5/32P_{ω,θ+4Δθ,t}ⁿ (24)

P_{ω,θ+2Δθ,t}ⁿ=−⅛P_{ω,θ-4Δθ,t}ⁿ+¾P_{ω,θ,t}ⁿ+⅜P_{ω,θ+4Δθ,t}ⁿ (25)

P_{ω,θ+3Δθ,t}ⁿ=− 3/32P_{ω,θ-4Δθ,t}ⁿ+ 7/16P_{ω,θ,t}ⁿ+ 21/32P_{ω,θ+4Δθ,t}ⁿ (26)

The above-described processing is performed in the processing of computing the first spatial spectrum in step S134 of FIG. 12. The other processing is similar to the case shown in FIG. 11, and thus the description thereof is omitted.

By interpolating the spatial spectrum in this way, the operation of the vector and the product of the matrix can be reduced, and the entire operation amount can be reduced.

### Fifth Embodiment

(FIGS. 17 to 19)

Next, with reference to FIGS. 17 to 19, the fifth embodiment will be described. FIG. 17 is a block diagram showing a configuration of the fifth embodiment of a sound source direction estimation device. In FIG. 17, an electric configuration of the sound source direction estimation device 1 of FIG. 1 is shown as a sound source direction estimation device 500.

The configuration of the sound source direction estimation device 500 of FIG. 17 is basically similar to the configuration of the sound source direction estimation device 300 of FIG. 10. However, the sound source direction estimation device 500 is different from the sound source direction estimation device 300 in that a signal line from a second peak detection unit 216 to a second spatial spectrum computation unit 482 is added. That is, the horizontal angle and the elevation angle detected by the second peak detection unit 216 are fed back to the second spatial spectrum computation unit 482. The other configuration is similar to the configuration in FIG. 10.

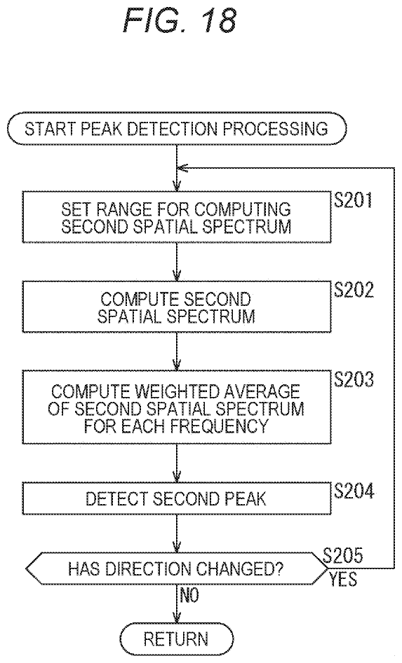

The sound source direction estimation device 300 of FIG. 10 has computed the spatial spectrum for the entire range of the elevation angle in the range of a predetermined horizontal angle near the direction (first horizontal angle) detected by the first peak detection unit 452. Then, thereafter, the maximum peak of the spatial spectrum has been determined by the second peak detection unit 216. In contrast, the sound source direction estimation device 500 detects the maximum peak with a smaller operation amount. The peak detection processing will be described with reference to FIG. 18. FIG. 18 is a flowchart illustrating the peak detection processing.

In step S201, the second spatial spectrum computation unit 482 sets a range for computing the second spatial spectrum. The range of the horizontal angle is a range of a predetermined horizontal angle near the first horizontal angle detected by the first peak detection unit 452. The range may be the same as the range for the sound source direction estimation device 300 (θ\hat{ }±s in FIG. 7), but may be a narrower range (θ\hat{ }±u (u≤s)). Moreover, the range of the elevation angle is not the entire range, but a limited predetermined range. The widths of these ranges are set in advance.

In step S202, the second spatial spectrum computation unit 482 computes the second spatial spectrum. This processing is similar to the processing of step S181 in FIG. 14. That is, the second spatial spectrum is computed by the above equation (18). However, the range in which the second spatial spectrum is computed is the limited range of the horizontal angle and the elevation angle set in the processing of step S201.

In step S203, the frequency information integration unit 483 computes a weighted average of the second spatial spectrum for each frequency. This processing is similar to the processing of step S182 in FIG. 14. That is, the weighted average of the second spatial spectrum for each frequency is computed by the above-described equations (19) and (20).

In step S204, the second peak detection unit 216 detects the second peak. This processing is similar to the processing of step S106 in FIG. 11. That is, out of the weighted averaged spatial spectra output by the frequency information integration unit 483, the spatial spectrum having the maximum value is detected, and the horizontal angle (second horizontal direction θ^{out}) and the elevation angle φ^{out} corresponding to the spatial spectrum are the sound source direction (θ^{out}, φ^{out}).

In step S205, the second peak detection unit 216 determines whether or not the direction has changed. That is, it is determined whether the horizontal angle detected this time is different from the horizontal angle detected last time. Furthermore, it is determined whether or not the elevation angle detected this time is different from the elevation angle detected last time. In a case where it is determined that at least one of the horizontal angle and the elevation angle is different from the last time, the process returns to step S201.

Again in step S201, the second spatial spectrum computation unit 482 sets a range for computing the second spatial spectrum. With respect to the horizontal angle and the elevation angle detected by the second peak detection unit 216, the range is a predetermined width range set in advance near the horizontal angle and the elevation angle.

In the newly set range, the second spatial spectrum is computed in step S202, the weighted average of the second spatial spectrum for each frequency is computed in step S203, and the second peak is detected again in step S204. Then, it is determined again in step S205 whether or not the direction has changed.

As described above, the processing of steps S201 to S205 is repeated until both the horizontal angle and the elevation angle no longer change. When both the horizontal angle and elevation angle stop changing, the horizontal angle and the elevation angle are supplied to the sound source direction presentation unit 311 as the final sound source direction (θ^{out}, φ^{out}).

The processing of FIG. 18 is performed in place of step S105 (second MUSIC processing of FIG. 14) and step S106 (processing of detecting peak) of FIG. 11. That is, the sound source direction estimation device 500 performs the processing of FIG. 18 after the processing of steps S101 to S104 of FIG. 11, and then performs the processing of step S107.

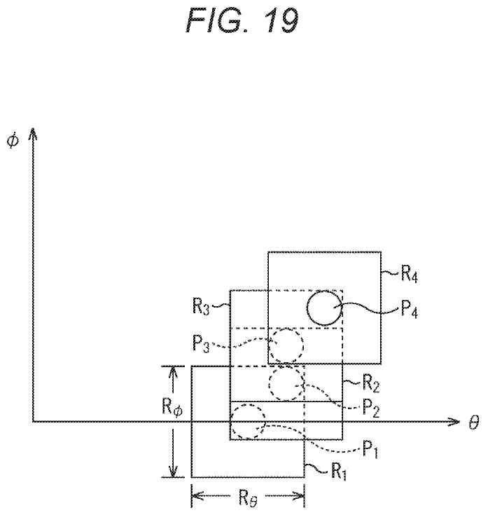

An outline of the processing of FIG. 18 will be described with reference to FIG. 19. FIG. 19 is a diagram illustrating the peak detection processing.

In FIG. 19, the horizontal axis represents the horizontal angle θ, and the vertical axis represents the elevation angle φ. A point P represents a point at a position expressed by the coordinates of the estimated horizontal angle and elevation angle, and R represents the range for computing the spatial spectrum. R_{θ} represents the width of the range R in the horizontal angle direction, and R_{φ} represents the width of the range R in the elevation angle direction. In this example, the width R_{θ} and the width R_{φ} have the same value, but may have different values.

When the horizontal angle (first horizontal angle) is detected by the first peak detection unit 452 in a state where the elevation angle φ is fixed (fixed to 0 degrees in the example of FIG. 19), with respect to the point P₁ of the first horizontal angle (elevation angle φ is 0 degrees), the range R₁ of the width R_{θ} in the horizontal angle direction and the width R_{φ} in the elevation angle direction is set as the first range for computing the second spatial spectrum. Then, the second spatial spectrum is computed in the range R₁, the maximum value of the peak is detected, and the point of the horizontal angle and the elevation angle corresponding to the peak is P₂.

Next, with respect to the point P₂, the range R₂ of the width R_{θ} in the horizontal angle direction and the width R_{φ} in the elevation angle direction is set as the second range for computing the second spatial spectrum. Then, the second spatial spectrum is computed in the range R₂, the maximum value of the peak is detected, and the point of the horizontal angle and the elevation angle corresponding to the peak is P₃. The point P₃ has the same horizontal angle as the point P₂, but has a different elevation angle.

Therefore, furthermore, with respect to the point P₃, the range R₃ of the width R_{θ} in the horizontal angle direction and the width R_{φ} in the elevation angle direction is set as the third range for computing the second spatial spectrum. Then, the second spatial spectrum is computed in the range R₃, the maximum value of the peak is detected, and the point of the horizontal angle and the elevation angle corresponding to the peak is P₄.

Moreover, with respect to the point P₄, the range R₄ of the width R_{θ} in the horizontal angle direction and the width R_{φ} in the elevation angle direction is set as the fourth range for computing the second spatial spectrum. Then, the second spatial spectrum is computed in the range R₄, and the maximum value of the peak is detected. However, the point of the horizontal angle and the elevation angle corresponding to the peak is P₄, and the horizontal angle and the elevation angle are the same as last time. Therefore, the horizontal angle and the elevation angle of the point P₄ are set as the final sound source direction (θ^{out}, φ^{out}).

In this way, since the range in which the operation is performed on the spatial spectrum is limited in the fifth embodiment, the operation amount therefor can be further reduced.

### Sixth Embodiment

(FIGS. 20 to 22)

Next, with reference to FIGS. 20 to 22, the sixth embodiment will be described. In the sixth embodiment, microphones 12 are combined into a pair as shown in FIG. 20. FIG. 20 is a diagram illustrating the pair of microphones. That is, in a similar manner to the case shown in FIG. 4, a microphone array 12 includes one microphone 12at on the upper surface of a housing 11 and six microphones 12as on the outer periphery. That is, the microphone array 12 includes a total of seven microphones 12a arranged three-dimensionally.

Then, one pair 12p is formed by the microphone 12at of one channel arranged three-dimensionally and one of the other six microphones 12as (of one channel). Therefore, the number of pairs 12p is six. Direction estimation is performed for each pair 12p, and results thereof are integrated into the final sound source direction. Note that what actually constitutes the pair may not be the microphone 12a itself, but is only required to be an output of the microphone 12a.

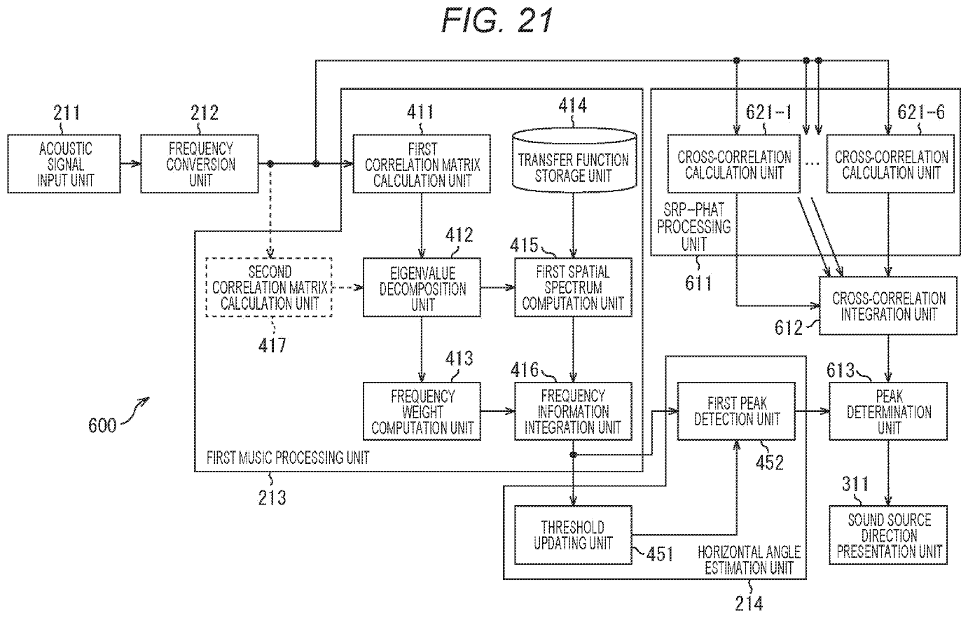

In a sound source direction estimation device 600 of FIG. 21, in place of the second MUSIC processing unit 215 and the second peak detection unit 216 of the sound source direction estimation device 300 of FIG. 10, a steered response power with the phase transform (SRP-PHAT) processing unit 611 and a cross-correlation integration unit 612 are provided. Moreover, a peak determination unit 613 is provided in place of the second peak detection unit 216. An output of a first peak detection unit 452 is supplied to the peak determination unit 613. Other configurations of the sound source direction estimation device 600 are similar to the configuration of the sound source direction estimation device 300. Since the second MUSIC processing unit 215 has been replaced by the SRP-PHAT processing unit 611 and the cross-correlation integration unit 612, the name of the first MUSIC processing unit 213 has been changed to a MUSIC processing unit 213. However, the function of the MUSIC processing unit 213 is the same as the function of the first MUSIC processing unit 213.

The SRP-PHAT processing unit 611 includes a number of cross-correlation calculation units 621-1 to 621-6 corresponding to the pairs 12p. The cross-correlation calculation unit 621-1 to the cross-correlation calculation unit 621-6 of the SRP-PHAT processing unit 611 each calculate the cross-correlation of the corresponding pair 12p. The cross-correlation integration unit 612 integrates the cross-correlation of the six pairs 12p. The peak determination unit 613 determines the final sound source direction from the peak of the integrated cross-correlation.

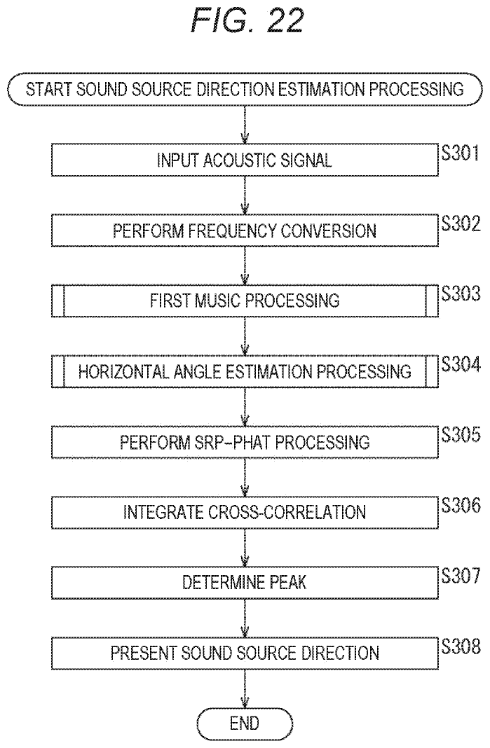

Next, sound source estimation processing of the sound source direction estimation device 600 will be described with reference to FIG. 22. FIG. 22 is a flowchart illustrating the sound source direction estimation processing.

The processing in steps S301 to S304 is similar to the processing in steps S101 to S104 of FIG. 11, respectively. While repeated detailed description thereof will be omitted, in step S303, the MUSIC processing unit 213 performs an operation on the first spatial spectrum, and the weighted average P\hat{ }ⁿ_{θ, t} of the first spatial spectrum for each frequency is computed by the above equations (14) and (15).

Then, in step S304, the horizontal angle estimation unit 214 detects, among the weighted averages P\hat{ }ⁿ_{θ, t} of the first spatial spectrum output from the MUSIC processing unit 213, those having a peak exceeding a threshold P^{th}_{θ, t}. Then, the horizontal angle θ\hat{ } corresponding to the detected weighted average P\hat{ }ⁿ_{θ, t} of the first spatial spectrum having the peak is output as the sound source direction when the elevation angle is fixed (first horizontal angle).

In step S305, the SRP-PHAT processing unit 611 performs SRP-PHAT processing. Specifically, the cross-correlation calculation unit 621-1 calculates the weighted cross-correlation R_{t,Δt,m.n} of the microphone 12at and the first microphone 12as that constitute the first pair 12p by the following equations (27) and (28). In these equations, m means the m-th microphone and n means the n-th microphone. In the example of FIG. 20, m=1, n 1, 2, 3, 4, 5, or 6. * in equation (27) represents a complex conjugation.

$$\begin{matrix}[ Equation 18 ] & \\ {φ}_{ω , t , m , n} = {z}_{ω , t , m} {z}_{ω , t , n}^{*} & ( 27 ) \\ {R}_{t , Δ t , m , n} = {\sum }_{ω} {W}_{ω , t , m , n} {φ}_{ω , t , m , n} {e}^{j ω Δ t} & ( 28 )\end{matrix}$$

The calculation of equation (27) is as follows. That is, from an STFT (or first Fourier transform (FFT)) signal z_{ω,t,m} of the m-th microphone 12at and a complex conjugation z*_{ω,t,n} of the STFT (or FFT) signal z_{ω,t,n} of the n-th microphone 12as, the correlation Φ_{ω,t,m,n} therebetween is calculated. Moreover, the correlation Φ_{ω,t,m,n} obtained by equation (27) is weighted by a weight w_{ω,t,m,n} as shown in equation (28), and inverse short time Fourier transform (ISTFT) is performed. Alternatively, inverse first Fourier transform (IFFT) is performed.

In a case where the following equation (29) is used as the weight w_{ω,t,m,n} for equation (28), this results in steered response power with the phase transform (SRP-PHAT). Alternatively, in a case where the following equation (30) is used as the weight w_{ω,t,m,n} for equation (28), this results in steered response power with the smoothed coherence transform (SRP-SCOT). By using SRP, the operation amount can be reduced.

[Equation 19]

w_{ω,t,m,n}=|ϕ_{ω,t,m,n}| (29)

w_{ω,t,m,n}=_{ϕw,t,m,m}ϕ_{ω,t,n,n} (30)

Similarly, the cross-correlation calculation unit 621-2 to the cross-correlation calculation unit 621-6 also calculate the weighted cross-correlation R_{t,Δt,m.n} of the microphone 12at and the microphone 12as of the corresponding pair 12p by the above-described equations (27) and (28). Thus, in the example of FIG. 21, the weighted cross-correlation R_{t,Δt,m.n} by the six pairs 12p is calculated.

In step S306, the cross-correlation integration unit 612 integrates the cross-correlation. That is, an operation is performed on R\hat{ }_{t,Δt,m} by equation (31) from the weighted cross-correlation R_{t,Δt,m.n} by the six pairs 12p calculated by the cross-correlation calculation unit 621-1 to the cross-correlation calculation unit 621-6.

$$\begin{matrix}[ Equation 20 ] & \\ {\hat{R}}_{t , Δ t , m} = {\sum }_{n} {R}_{t , Δ t , m , n} & ( 31 )\end{matrix}$$

In step S307, the peak determination unit 613 determines the peak. That is, an operation by equation (32) is performed on a set of horizontal angle θ and elevation angle φ that maximizes R\hat{ }_{t,Δt,m} on which an operation is performed by equation (31), and the set is determined as the sound source direction (θ^{out}, φ^{out})

$$\begin{matrix}[ Equation 21 ] & \\ ( {θ}^{o u t} , {φ}^{out} ) = {arg max}_{θ , φ} {\hat{R}}_{t , Δ t , m} & ( 32 )\end{matrix}$$

It can also be understood that the processing in step S306 and step S307 described above is performed by the cross-correlation integration unit 612 and the peak determination unit 613 executing the following equation (33).

$$\begin{matrix}[ Equation 22 ] & \\ ( {θ}^{o u t} , {φ}^{out} ) = {arg max}_{\tilde{θ} , φ} {\sum }_{n} {R}_{t , Δ t , m , n} & ( 33 )\end{matrix}$$

That is, the range of operation by the peak determination unit 613 is limited to, with respect to the first horizontal angle θ\hat{ } supplied from the first peak detection unit 452, a predetermined range near the first horizontal angle (θ\hat{ }±s), that is, θ\hat{ }−s<θ˜<θ\hat{ }+s. Then, in the range, an operation is performed on the final second horizontal angle θ^{out} and the elevation angle φ^{out}. With this operation, the operation amount can be reduced.

Δt is a function of the horizontal angle θ and the elevation angle φ, and furthermore, m and n, as expressed in equation (2) described above. R\hat{ }_{t,Δt,m} including the element of Δt can calculate the sound source direction (θ^{out}, φ^{out}) from equation (32) or equation (33) of the function argmax.

In the sixth embodiment, the range can be narrowed down to some extent, and the maximum value within the narrowed range is determined. Therefore, it is possible to estimate a plurality of directions at the same time.

### Seventh Embodiment

(FIGS. 23 and 24)

Next, with reference to FIGS. 23 and 24, the seventh embodiment will be described. FIG. 23 is a block diagram showing a configuration of the seventh embodiment of a sound source direction estimation device. In FIG. 23, an electric configuration of the sound source direction estimation device 1 of FIG. 1 is shown as a sound source direction estimation device 700.

The sound source direction estimation device 700 includes an acoustic signal input unit 211, a frequency conversion unit 212, an SRP-PHAT processing unit 611, a cross-correlation integration unit 612, a peak detection unit 613, and a sound source direction presentation unit 311. The SRP-PHAT processing unit 611 includes a cross-correlation calculation unit 621-1 to a cross-correlation calculation unit 621-6.

That is, the seventh embodiment of FIG. 23 has a configuration in which the MUSIC processing unit 213 and the horizontal angle estimation unit 214 in the sixth embodiment of FIG. 21 are omitted. However, since the first peak detection unit 452 of FIG. 21 is omitted, the peak determination unit 613 does not receive a signal from the first peak detection unit 452.

Next, sound source direction estimation processing of the sound source direction estimation device 700 will be described with reference to the flowchart of FIG. 24. FIG. 24 is a flowchart illustrating the sound source direction estimation processing.

The processing in step S351 and step S352 is similar to the processing in step S301 and step S302 of FIG. 22, respectively. That is, in step S351, the acoustic signal input unit 211 inputs an acoustic signal. For example, seven microphones 12as and a microphone 12at arranged as shown in FIG. 20 are combined as pairs, collect a sound from a sound source in a predetermined direction and output a corresponding acoustic signal.

In step S352, the frequency conversion unit 212 performs frequency conversion on the acoustic signal input from the acoustic signal input unit 211. That is, the acoustic signal is converted from a signal of a time-base domain to a signal of a frequency domain. For example, DFT or STFT processing is performed for every frame. For example, a frame length can be 32 ms and a frame shift can be 10 ms. The cross-correlation calculation unit 621-1 to the cross-correlation calculation unit 621-6 each acquire a signal in the frequency domain of the corresponding pair of the six pairs 12p.

Next, in step S353, SRP-PHAT processing is performed by the SRP-PHAT processing unit 611. In the seventh embodiment of FIG. 23, the MUSIC processing unit 213 and the horizontal angle estimation unit 451 in the processing of the sixth embodiment of FIG. 21 are omitted. Therefore, the first MUSWIC processing in step S303 of FIG. 22 and the horizontal angle estimation processing in step S304 are omitted.

The SRP-PHAT processing of step S353 and the processing of integrating the cross-correlation of step S354 are similar to the SRP-PHAT processing of step S305 and the processing of integrating the cross-correlation of step S306 in FIG. 22.

That is, in step S353, in a similar manner to the SRP-PHAT processing of step S305 described above, the cross-correlation calculation unit 621-1 to the cross-correlation calculation unit 621-6 perform the calculation by the above-described equations (27) and (28). With this calculation, the weighted cross-correlation R_{t,Δt,m.n} of the microphone 12at and the microphone 12as of the corresponding pair 12p is calculated.

In step S354, the cross-correlation integration unit 612 performs processing of integrating the cross-correlation. That is, an operation is performed on R\hat{ }_{t,Δt,m,n} by the above-described equation (31).

In step S355, the peak determination unit 613 determines the peak. That is, an operation by equation (32) is performed on a set of horizontal angle θ and elevation angle φ that maximizes R\hat{ }_{t,Δt,m,n} on which an operation is performed by equation (31), and the set is determined as the sound source direction (θ^{out}, φ^{out}).

It can also be understood that the processing of step S354 and step S355 described above is performed by the cross-correlation integration unit 612 and the peak determination unit 613 executing equation (34).

$$\begin{matrix}[ Equation 23 ] & \\ ( {θ}^{o u t} , {φ}^{out} ) = {arg max}_{θ , φ} {\sum }_{n} {R}_{t , Δ t , m , n} & ( 34 )\end{matrix}$$

However, unlike the sixth embodiment of FIG. 21, the first peak detection unit 452 is omitted, and therefore the first horizontal angle θ\hat{ } is not supplied from the first peak detection unit 452 to the peak determination unit 613. Therefore, in the seventh embodiment of FIG. 23, the range of the operation by the peak determination unit 613 is not limited to θ\hat{ }−s<θ˜<θ\hat{ }+s. That is, an operation is performed directly on the final second horizontal angle θ^{out} and the elevation angle φ^{out}. Therefore, it is difficult to expect the effect of reducing the operation amount by limiting the range, but since the SRP operation is used, the operation amount can be reduced more than in a case where the MUSIC method is used as the second estimation unit 113.

In step S356, the sound source direction presentation unit 311 presents the sound source direction. That is, the sound source direction determined in the processing of step S355 is presented to the user. This processing is similar to the processing of step S308 in FIG. 22.

In the sixth embodiment, since the range can be narrowed down to some extent and the maximum value is determined in the narrowed down range, a plurality of directions can be estimated at the same time. In the seventh embodiment, one direction is output in each frame.

<Experimental Result>

(FIGS. 25 to 28)

Next, as in the embodiment of FIG. 10, in a case where the horizontal angle and the elevation angle are estimated, and in a case where only the horizontal angle is estimated without estimating the elevation angle, a result of performing an actual estimation experiment will be described. FIG. 25 is a diagram illustrating a position of a sound source. As shown in FIG. 25, an experiment was performed in which a sound source is disposed at positions with a distance of 150 cm from the microphone array 12 at horizontal angles 0°, 30°, and 60° and a predetermined elevation angle, and the sound source is estimated. The measurement was made with the estimation performed at 3° intervals for both the horizontal angle and the elevation angle, and the elevation angle covering the entire horizontal angle.

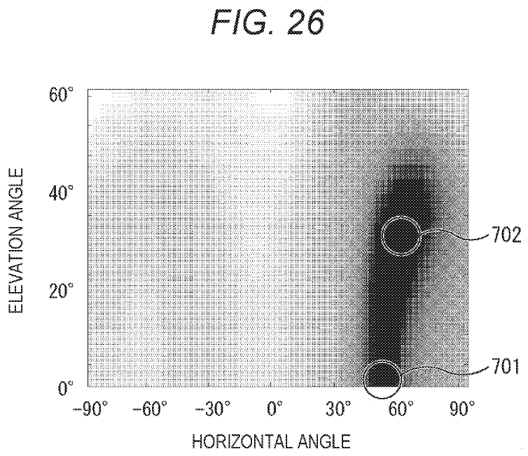

FIG. 26 is a diagram showing an example of a spatial spectrum. FIG. 26 shows a spatial spectrum in a case where the horizontal angle and the elevation angle measured in a case where the sound source is disposed at a horizontal angle of 60° and an elevation angle of 25.5° are estimated (3 Dimensions-Direction of Arrival (3D-DOA)). The horizontal axis represents the horizontal angle, and the vertical axis represents the elevation angle. The point 701 represents a result in a case where the elevation angle is not estimated and only the horizontal angle is estimated (2 Dimensions-Direction of Arrival (2D-DOA)). The point 702 represents a result of 3D-DOA. FIG. 26 shows that the horizontal angles of both points are different.

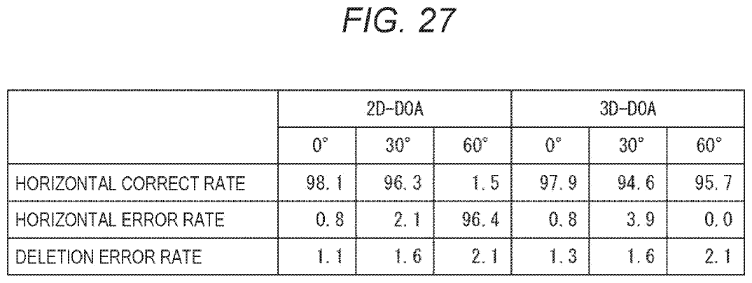

FIG. 27 is a diagram showing an evaluation result. For each of 2D-DOA and 3D-DOA, the horizontal correct rate, the horizontal error rate, and the deletion rate in a case where the sound source is disposed at the horizontal angle of 0°, 30°, or 60° are shown. In particular, for 2D-DOA, the horizontal correct rate and the horizontal error rate at the position of 60° are 1.5 and 96.4, respectively, whereas for 3D-DOA, the horizontal correct rate and the horizontal error rate are 95.7 and 0.0, respectively. The correct rate in the horizontal direction has been improved. Note that the horizontal angle having an error of ±6° or less was allowed as correct, and the evaluation was performed depending on whether or not the direction was detected for each frame of 30 ms.

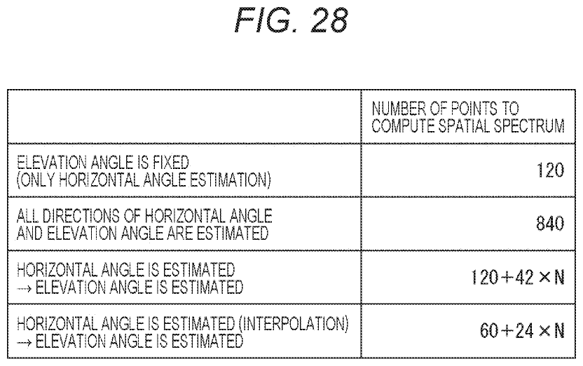

Next, the operation amount will be described. FIG. 28 is a diagram illustrating the operation amount. It is assumed that the horizontal angle is estimated from −180° to 177° in increments of 3°, the elevation angle is estimated from 0° to 60° in increments of 10°, and N sound sources are found by horizontal angle estimation. Furthermore, it is assumed that the elevation angle is estimated within a range of ±9° with respect to the direction found by horizontal angle estimation.

The number of points to compute the spatial spectrum is 120 in a case where the elevation angle is fixed (in a case where only the horizontal angle is estimated), 840 in a case where the entire direction of the horizontal angle and the elevation angle is estimated, and 120+42×N in a case where the horizontal angle is estimated and then the horizontal angle and the elevation angle are estimated for the found direction. Furthermore, in a case where the horizontal angle is estimated by skipping one and interpolation is performed therebetween by the above equation (21), the number of points to compute the spatial spectrum is 60+24×N. In a case where the horizontal angle is estimated and then the horizontal angle and the elevation angle are estimated for the found direction, and in a case where the horizontal angle is estimated by skipping one and interpolation is performed therebetween by the above equation (21), it can be seen that the number of points to compute the spatial spectrum is extremely smaller than in a case where the entire direction of the horizontal angle and the elevation angle is estimated.

In the above description, the estimated sound source direction is presented to the user, but there are other uses of the estimated sound source direction. For example, the sound source direction can be used for automatic switching to the near mode. In a situation where the elevation angle is large relative to the microphone array 12 of a device, it is likely that the user gives utterance after approaching the device. As the distance is shorter, the elevation angle tends to increase even with a slight difference in height. There may be a case where the elevation angle is large but actually the user is not close, such as utterance from a different floor.

In a case where a fairly large elevation angle is determined by the sound source direction estimation, it can be determined that the user is close to the device and the signal processing configuration can be switched. For example, a configuration may be used in which after voice activity detection (VAD) (voice/non-voice determination) is performed, a voice is extracted by beam forming (BF), noise reduction (NR) is further performed, and voice recognition is performed. That is, in a case where the user is close to the device, the signal-to-noise (SN) ratio of the voice will be good, and therefore switching may be performed such that the input voice is recognized as it is without performing direction estimation.

<Computer>

(FIG. 29)

A series of types of processing described above can be performed by hardware, or can be performed by software. In this case, for example, each device includes a personal computer as shown in FIG. 29. FIG. 29 is a block diagram showing a configuration example of the personal computer.

In FIG. 29, a central processing unit (CPU) 921 performs various types of processing according to a program stored in a read only memory (ROM) 922 or a program loaded from a storage unit 928 to a random access memory (RAM) 923. The RAM 923 also stores data necessary for the CPU 921 to perform various types of processing and the like as needed.

The CPU 921, the ROM 922, and the RAM 923 are connected to one another via a bus 924. An input-output interface 925 is also connected to the bus 924.

An input unit 926 including a keyboard, a mouse, or the like, an output unit 927 including a display such as a CRT or LCD, a speaker, and the like, a storage unit 928 including a hard disk or the like, and a communication unit 929 including a modem, a terminal adapter, or the like are connected to the input-output interface 925. The communication unit 929 performs communication processing via a network, such as, for example, the Internet.

A drive 930 is also connected to the input-output interface 925 as necessary. A removable medium 931 such as a magnetic disk, an optical disk, a magneto-optical disk, or a semiconductor memory is appropriately mounted. A computer program read therefrom is installed in the storage unit 48 as necessary.

Note that in this specification, steps describing the program to be recorded on the recording medium includes not only processing to be executed on a time-series basis according to the listed order, but also processing that may be not necessarily executed on a time-series basis but is executed in parallel or individually.

Furthermore, embodiments of the present technology are not limited to the embodiments described above, and various modifications may be made without departing from the spirit of the present technology.

### OTHER

The present technology can also have the following configurations.

(1)

A sound source direction estimation device including:

a first estimation unit configured to estimate a first horizontal angle that is a horizontal angle of a sound source direction from an input acoustic signal; and

a second estimation unit configured to estimate a second horizontal angle that is the horizontal angle of the sound source direction and an elevation angle, with respect to the first horizontal angle, in a predetermined range near the first horizontal angle.

(2)

The sound source direction estimation device according to (1) described above, further including

an input unit configured to input the acoustic signal from a microphone array including a plurality of microphones.

(3)

The sound source direction estimation device according to (1) or (2) described above, in which

in the microphone array, the plurality of microphones is arranged three-dimensionally.

(4)

The sound source direction estimation device according to any one of (1) to (3) described above, in which

the first estimation unit performs an operation on a first spatial spectrum, and estimates the first horizontal angle on the basis of the first spatial spectrum.

(5)

The sound source direction estimation device according to any one of (1) to (4) described above, in which

the first estimation unit includes a first processing unit that performs an operation on the first spatial spectrum by a MUSIC method.

(6)

The sound source direction estimation device according to any one of (1) to (5) described above, in which

the second estimation unit includes a second processing unit that performs an operation on a second spatial spectrum by the MUSIC method.

(7)

The sound source direction estimation device according to any one of (1) to (6) described above, in which

the first estimation unit further includes a horizontal angle estimation unit configured to estimate the first horizontal angle on the basis of the first spatial spectrum on which the first processing unit performs an operation.

(8)

The sound source direction estimation device according to any one of (1) to (7) described above, in which

the second processing unit performs an operation on the second spatial spectrum by the MUSIC method in a range of the entire elevation angle in a predetermined range of the horizontal angle near the first horizontal angle.

(9)

The sound source direction estimation device according to any one of (1) to (8) described above, in which

the first processing unit includes a first correlation matrix calculation unit that calculates a correlation matrix of a target sound signal of respective frequencies for every time frame of the acoustic signal for performing an operation on the first spatial spectrum.

(10)

The sound source direction estimation device according to any one of (1) to (9) described above, in which

the first processing unit further includes a second correlation matrix calculation unit that calculates a correlation matrix of a noise signal of respective frequencies for every time frame of the acoustic signal for performing an operation on the first spatial spectrum.

(11)

The sound source direction estimation device according to any one of (1) to (10) described above, in which

the second estimation unit further includes a detection unit that detects the sound source direction from a peak of the second spatial spectrum.

(12)

The sound source direction estimation device according to any one of (1) to (11) described above, further including

a presentation unit configured to present the sound source direction detected by the detection unit.

(13)

The sound source direction estimation device according to any one of (1) to (12) described above, in which

the presentation unit changes a presentation state according to the estimated elevation angle.

(14)

The sound source direction estimation device according to any one of (1) to (12) described above, in which

the first processing unit thins out the direction in which the first spatial spectrum is calculated, and performs an operation on the first spatial spectrum in the thinned out direction by interpolation.

(15)

The sound source direction estimation device according to any one of (1) to (14) described above, in which

the second estimation unit repeats processing of computing a range in which the second spatial spectrum is computed in a range limited in both the horizontal angle and the elevation angle, and detecting the peak of the computed second spatial spectrum until both the horizontal angle and the elevation angle no longer change.

(16)

The sound source direction estimation device according to any one of (1) to (15) described above, in which

the second estimation unit includes an SRP processing unit that processes a pair signal of one channel of the microphones arranged three-dimensionally and another one channel of the microphones.

(17)

The sound source direction estimation device according to any one of (1) to (16) described above, in which the SRP processing unit calculates a cross-correlation of a plurality of the pair signals, and in the predetermined range near the first horizontal angle, the SRP processing unit estimates the second horizontal angle and the elevation angle from a peak of the cross-correlation.

(18)

The sound source direction estimation device according to any one of (1) to (17) described above, in which

the first estimation unit does not estimate the first horizontal angle, and

the SRP processing unit estimates the second horizontal angle and the elevation angle from a peak of the cross-correlation.

(19)

A method of estimating a sound source direction of a sound source direction estimation device, the method including:

a first step of estimating a first horizontal angle that is a horizontal angle of the sound source direction from an input acoustic signal; and

a second step of estimating a second horizontal angle that is the horizontal angle of the sound source direction and an elevation angle, with respect to the first horizontal angle, in a predetermined range near the first horizontal angle.

(20)

A program for causing a computer to execute sound source direction estimation processing including:

a first step of estimating a first horizontal angle that is a horizontal angle of the sound source direction from an input acoustic signal; and

a second step of estimating a second horizontal angle that is the horizontal angle of the sound source direction and an elevation angle, with respect to the first horizontal angle, in a predetermined range near the first horizontal angle.

### REFERENCE SIGNS LIST

1 Sound source direction estimation device
12 Microphone array
12a Microphone
13 Display unit
111 Acoustic signal input unit
112 First estimation unit
113 Second estimation unit
211 Acoustic signal input unit
212 Frequency conversion unit
213 First MUSIC processing unit
214 Horizontal angle estimation unit
215 Second MUSIC processing unit
216 Peak detection unit

1. A sound source direction estimation device comprising:
a first estimation unit configured to estimate a first horizontal angle that is a horizontal angle of a sound source direction from an input acoustic signal; and
a second estimation unit configured to estimate a second horizontal angle that is the horizontal angle of the sound source direction and an elevation angle, with respect to the first horizontal angle, in a predetermined range near the first horizontal angle.

2. The sound source direction estimation device according to claim 1, further comprising
an input unit configured to input the acoustic signal from a microphone array including a plurality of microphones.

3. The sound source direction estimation device according to claim 2, wherein
in the microphone array, the plurality of microphones is arranged three-dimensionally.

4. The sound source direction estimation device according to claim 3, wherein
the first estimation unit performs an operation on a first spatial spectrum, and estimates the first horizontal angle on a basis of the first spatial spectrum.

5. The sound source direction estimation device according to claim 4, wherein
the first estimation unit includes a first processing unit that performs an operation on the first spatial spectrum by a MUSIC method.

6. The sound source direction estimation device according to claim 5, wherein
the second estimation unit includes a second processing unit that performs an operation on a second spatial spectrum by the MUSIC method.

7. The sound source direction estimation device according to claim 5, wherein
the first estimation unit further includes a horizontal angle estimation unit configured to estimate the first horizontal angle on a basis of the first spatial spectrum on which the first processing unit performs an operation.

8. The sound source direction estimation device according to claim 6, wherein
the second processing unit performs an operation on the second spatial spectrum by the MUSIC method in a range of the entire elevation angle in a predetermined range of the horizontal angle near the first horizontal angle.

9. The sound source direction estimation device according to claim 5, wherein
the first processing unit includes a first correlation matrix calculation unit that calculates a correlation matrix of a target sound signal of respective frequencies for every time frame of the acoustic signal for performing an operation on the first spatial spectrum.

10. The sound source direction estimation device according to claim 9, wherein
the first processing unit further includes a second correlation matrix calculation unit that calculates a correlation matrix of a noise signal of respective frequencies for every time frame of the acoustic signal for performing an operation on the first spatial spectrum.

11. The sound source direction estimation device according to claim 6, wherein
the second estimation unit further includes a detection unit that detects the sound source direction from a peak of the second spatial spectrum.

12. The sound source direction estimation device according to claim 11, further comprising
a presentation unit configured to present the sound source direction detected by the detection unit.

13. The sound source direction estimation device according to claim 12, wherein
the presentation unit changes a presentation state according to the estimated elevation angle.

14. The sound source direction estimation device according to claim 5, wherein
the first processing unit thins out the direction in which the first spatial spectrum is calculated, and performs an operation on the first spatial spectrum in the thinned out direction by interpolation.

15. The sound source direction estimation device according to claim 11, wherein
the second estimation unit repeats processing of computing a range in which the second spatial spectrum is computed in a range limited in both the horizontal angle and the elevation angle, and detecting the peak of the computed second spatial spectrum until both the horizontal angle and the elevation angle no longer change.

16. The sound source direction estimation device according to claim 3, wherein
the second estimation unit includes an SRP processing unit that processes a pair signal of one channel of the microphones arranged three-dimensionally and another one channel of the microphones.

17. The sound source direction estimation device according to claim 16, wherein
the SRP processing unit calculates a cross-correlation of a plurality of the pair signals, and in the predetermined range near the first horizontal angle, the SRP processing unit estimates the second horizontal angle and the elevation angle from a peak of the cross-correlation.

18. The sound source direction estimation device according to claim 16, wherein
the first estimation unit does not estimate the first horizontal angle, and
the SRP processing unit estimates the second horizontal angle and the elevation angle from a peak of the cross-correlation.

19. A method of estimating a sound source direction of a sound source direction estimation device, the method comprising:
a first step of estimating a first horizontal angle that is a horizontal angle of the sound source direction from an input acoustic signal; and
a second step of estimating a second horizontal angle that is the horizontal angle of the sound source direction and an elevation angle, with respect to the first horizontal angle, in a predetermined range near the first horizontal angle.

20. A program for causing a computer to execute sound source direction estimation processing comprising:
a first step of estimating a first horizontal angle that is a horizontal angle of the sound source direction from an input acoustic signal; and
a second step of estimating a second horizontal angle that is the horizontal angle of the sound source direction and an elevation angle, with respect to the first horizontal angle, in a predetermined range near the first horizontal angle.
